(19) United States
(12) Patent Application Publication
(10) Pub. No.: US 2025/0291157 A1
(43) Pub. Date: Sep. 18, 2025

(54) OPTICAL IMAGING LENS ASSEMBLY

(71) Applicant: ZHEJIANG SUNNY OPTICS CO., LTD., Yuyao City (CN)

(72) Inventors: Ren DING, Yuyao City (CN); Yang LI, Yuyao City (CN); Zeguang WANG, Yuyao City (CN); Jiadong ZHU, Yuyao City (CN); Xiancui DING, Yuyao City (CN); Jianke WENREN, Yuyao City (CN); Fujian DAI, Yuyao City (CN); Liefeng ZHAO, Yuyao City (CN)

(73) Assignee: ZHEJIANG SUNNY OPTICS CO., LTD., Yuyao City (CN)

(21) Appl. No.: 18/979,096

(22) Filed: Dec. 12, 2024

(30) Foreign Application Priority Data
Mar. 15, 2024 (CN) 202410302158.8

(51) Int. Cl. G02B 13/00; G02B 9/62

(52) U.S. Cl. CPC G02B 13/0045; G02B 9/62

(57) ABSTRACT

The present disclosure discloses an optical imaging lens assembly, including a lens barrel and a lens group and a spacing element. The lens group includes first to sixth lenses; the first lens has a negative refractive power, a convex object-side surface, and a concave image-side surface; the second lens has a positive refractive power, a convex object-side surface, and a concave image-side surface; the third lens has a positive refractive power, a convex object-side surface, and a convex image-side surface; the fourth lens has a positive refractive power, a convex object-side surface, and a convex image-side surface; the fifth lens has a negative refractive power, and a concave object-side surface; and the sixth lens has a positive refractive power, and a convex object-side surface. There is a first spacing element in direct contact with the image-side surface of the first lens between the first lens and the second lens.

### CROSS-REFERENCE TO RELATED APPLICATIONS

This patent application claims the priority from Chinese Patent Application No. 202410302158.8, filed on Mar. 15, 2024 and entitled “Optical Imaging Lens Assembly,” the entire disclosure of which is hereby incorporated by reference.

### TECHNICAL FIELD

The present disclosure relates to the field of optical elements, and specifically to an optical imaging lens assembly.

### BACKGROUND

With the rapid development of the mobile phone industry, various selling points emerge in an endless stream. With the in-depth exploration of various aspects of performance, more and more cutting-edge functions are developed and introduced into mass production. In terms of photography, conventional pixels and framing sizes can no longer meet market demands.

### SUMMARY

The present disclosure provides an optical imaging lens assembly, including a lens barrel, and a lens group and at least one spacing element that are accommodated in the lens barrel, where the lens group includes a first lens, a second lens, a third lens, a fourth lens, a fifth lens and a sixth lens that are sequentially arranged along an optical axis from an object side to an image side; the first lens has a negative refractive power, an object-side surface of the first lens is a convex surface, and an image-side surface of the first lens is a concave surface; the second lens has a positive refractive power, an object-side surface of the second lens is a convex surface, and an image-side surface of the second lens is a concave surface; the third lens has a positive refractive power, an object-side surface of the third lens is a convex surface, and an image-side surface of the third lens is a convex surface; the fourth lens has a positive refractive power, an object-side surface of the fourth lens is a convex surface, and an image-side surface of the fourth lens is a convex surface; the fifth lens has a negative refractive power, and an object-side surface of the fifth lens is a concave surface; and the sixth lens has a positive refractive power, and an object-side surface of the sixth lens is a convex surface, the at least one spacing element includes: a first spacing element, positioned between the first lens and the second lens and in direct contact with the image-side surface of the first lens, and the optical imaging lens assembly satisfies: 0<(D0s−d0s)/(EPD×tan(Semi-FOV))≤0.5, and 2.0<d1m/(R2×N1)<3.0, where D0s is an outer diameter of an object-side end surface of the lens barrel, dos is an inner diameter of the object-side end surface of the lens barrel, EPD is an entrance pupil diameter of the optical imaging lens assembly, Semi-FOV is half of a maximal field-of-view of the optical imaging lens assembly, dim is an inner diameter of an image-side surface of the first spacing element, R2 is a radius of curvature of the image-side surface of the first lens, and N1 is a refractive index of the first lens.

In an implementation, an abbe number V1 of the first lens, a distance EP01 from the object-side end surface of the lens barrel to an object-side surface of the first spacing element on the optical axis, a maximal thickness CP1 of the first spacing element, an effective focal length f1 of the first lens and a radius of curvature R1 of the object-side surface of the first lens satisfy: −15.0<V1×(EP01+CP1)/(f1×R1)<−10.5.

In an implementation, a maximal effective radius DT11 of the object-side surface of the first lens, a maximal effective radius DT12 of the image-side surface of the first lens, an outer diameter D1s of the object-side surface of the first spacing element and an inner diameter d1s of the object-side surface of the first spacing element satisfy:

$$0.3 < ( DT 11 - DT 12 ) / ( D 1 s - d 1 s ) < 1.3 .$$

In an implementation, the at least one spacing element further includes: a second spacing element, positioned between the second lens and the third lens and in direct contact with the image-side surface of the second lens, and an outer diameter D2s of an object-side surface of the second spacing element and a maximal effective radius DT22 of the image-side surface of the second lens satisfy: 6.0<D2s/DT22<10.5.

In an implementation, the at least one spacing element further includes: a second spacing element, positioned between the second lens and the third lens and in direct contact with the image-side surface of the second lens, and a radius of curvature R3 of the object-side surface of the second lens, an effective focal length f2 of the second lens, a refractive index N2 of the second lens, a center thickness CT2 of the second lens on the optical axis and a distance EP12 from the image-side surface of the first spacing element to an object-side surface of the second spacing element on the optical axis satisfy: 4.5 mm<|R3×f2|/(N2+CT2+EP12)<8.5 mm.

In an implementation, the at least one spacing element further includes: a third spacing element, positioned between the third lens and the fourth lens and in direct contact with the image-side surface of the third lens, and an air spacing T34 between the third lens and the fourth lens on the optical axis, a maximal thickness CP3 of the third spacing element, an abbe number V3 of the third lens and an effective focal length f3 of the third lens satisfy: −0.2<(T34−CP3)×V3/f3<1.0.

In an implementation, the at least one spacing element further includes: a third spacing element, positioned between the third lens and the fourth lens and in direct contact with the image-side surface of the third lens, and an outer diameter D3s of an object-side surface of the third spacing element, a radius of curvature R6 of the image-side surface of the third lens, an outer diameter D3m of an image-side surface of the third spacing element and a radius of curvature R7 of the object-side surface of the fourth lens satisfy: 1.0<D3s/R6+D3m/R7<4.0.

In an implementation, the at least one spacing element further includes: a third spacing element, positioned between the third lens and the fourth lens and in direct contact with the image-side surface of the third lens; and a fourth spacing element, positioned between the fourth lens and the fifth lens and in direct contact with the image-side surface of the fourth lens, and a distance EP34 from an image-side surface of the third spacing element to an object-side surface of the fourth spacing element on the optical axis, a maximal thickness CP4 of the fourth spacing element, an effective focal length f4 of the fourth lens and a refractive index N4 of the fourth lens satisfy: 0<(EP34+CP4)/(f4×N4)<0.3.

In an implementation, the at least one spacing element further includes: a fourth spacing element, positioned between the fourth lens and the fifth lens and in direct contact with the image-side surface of the fourth lens; and a fifth spacing element, positioned between the fifth lens and the sixth lens and in direct contact with an image-side surface of the fifth lens, and an inner diameter d5s of an object-side surface of the fifth spacing element, an inner diameter d4m of an image-side surface of the fourth spacing element and a radius of curvature R10 of the image-side surface of the fifth lens satisfy: −1.0<(d5s−d4m)/R10<0.5.

In an implementation, the at least one spacing element further includes: a fifth spacing element, positioned between the fifth lens and the sixth lens and in direct contact with an image-side surface of the fifth lens, and an outer diameter D5m of an image-side surface of the fifth spacing element and a maximal effective radius DT61 of the object-side surface of the sixth lens satisfy: 3.5<D5m/DT61<5.0.

In an implementation, the at least one spacing element further includes: a fourth spacing element, positioned between the fourth lens and the fifth lens and in direct contact with the image-side surface of the fourth lens; and a fifth spacing element, positioned between the fifth lens and the sixth lens and in direct contact with an image-side surface of the fifth lens, and a distance EP45 from an image-side surface of the fourth spacing element to an object-side surface of the fifth spacing element on the optical axis, a maximal thickness CP5 of the fifth spacing element, a center thickness CT5 of the fifth lens on the optical axis and a radius of curvature R12 of an image-side surface of the sixth lens satisfy: −0.2<(EP45+CP5+CT5)/R12<1.0.

### BRIEF DESCRIPTION OF THE DRAWINGS

In combination with the accompanying drawings, other features, objectives and advantages of the present disclosure will become more apparent through the following detailed descriptions of non-limiting implementations. In the accompanying drawings:

FIG. 1 is a schematic diagram of a structure and relevant parameters of an optical imaging lens assembly according to an exemplary implementation of the present disclosure;

FIG. 2 is a schematic structural diagram of an optical imaging lens assembly according to Embodiment 1 of the present disclosure;

FIG. 3 is a schematic structural diagram of an optical imaging lens assembly according to Embodiment 2 of the present disclosure;

FIG. 4, FIG. 5 and FIG. 6 respectively illustrate a longitudinal aberration curve, an astigmatic curve and a lateral color curve of the optical imaging lens assemblies according to Embodiments 1 and 2 of the present disclosure;

FIG. 7 is a schematic structural diagram of an optical imaging lens assembly according to Embodiment 3 of the present disclosure;

FIG. 8 is a schematic structural diagram of an optical imaging lens assembly according to Embodiment 4 of the present disclosure;

FIG. 9, FIG. 10 and FIG. 11 respectively illustrate a longitudinal aberration curve, an astigmatic curve and a lateral color curve of the optical imaging lens assemblies according to Embodiments 3 and 4 of the present disclosure;

FIG. 12 is a schematic structural diagram of an optical imaging lens assembly according to Embodiment 5 of the present disclosure;

FIG. 13 is a schematic structural diagram of an optical imaging lens assembly according to Embodiment 6 of the present disclosure;

FIG. 14, FIG. 15 and FIG. 16 respectively illustrate a longitudinal aberration curve, an astigmatic curve and a lateral color curve of the optical imaging lens assemblies according to Embodiments 5 and 6 of the present disclosure;

FIG. 17 is a schematic structural diagram of an optical imaging lens assembly according to Embodiment 7 of the present disclosure;

FIG. 18 is a schematic structural diagram of an optical imaging lens assembly according to Embodiment 8 of the present disclosure;

FIG. 19, FIG. 20 and FIG. 21 respectively illustrate a longitudinal aberration curve, an astigmatic curve and a lateral color curve of the optical imaging lens assemblies according to Embodiments 7 and 8 of the present disclosure; and

FIGS. 22-25 respectively illustrate spot diagrams of an optical imaging lens assembly according to exemplary implementations that perform stray light simulation tests when satisfying different conditions.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, without departing from the teachings of the present disclosure, the first lens discussed below may also be referred to as the second lens or the third lens.

In the accompanying drawings, the thicknesses, sizes and shapes of the lenses are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near an optical axis. If a lens surface is a convex surface and the position of the convex surface is not defined, it represents that the lens surface is a convex surface at least at the paraxial area. If the lens surface is a concave surface and the position of the concave surface is not defined, it represents that the lens surface is a concave surface at least at the paraxial area. The determination for the surface shape at the paraxial area may be according to the determination approach commonly used in the art, for example, whether the surface is concave or convex is determined according to whether the R value (R refers to a radius of curvature at the paraxial area) is positive or negative. Herein, a surface of each lens that is closest to a photographed object is referred to as the object-side surface of the lens, and a surface of each lens that is closest to an image plane is referred to as the image-side surface of the lens. For the object-side surface, it is determined that the surface is a convex surface when the R value is positive, and it is determined that the surface is a concave surface when the R value is negative. For the image-side surface, it is determined that the surface is a concave surface when the R value is positive, and it is determined that the surface is a convex surface when the R value is negative.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, expressions such as “at least one of,” when preceding a list of listed features, modify the entire list of features rather than an individual element in the list. Further, the use of “may,” when describing the implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that the embodiments in the present disclosure and the features in the embodiments may be combined with each other on a non-conflict basis. The following embodiments only express several implementations of the present disclosure, and the descriptions thereof are relatively specific and detailed, but cannot be understood as a limitation to the scope of the present disclosure. It should be pointed out that, for those of ordinary skill in the art, several variations and improvements can be made without departing from the concept of the present disclosure, and these variations and improvements all fall within the scope of protection of the present disclosure. The present disclosure will be described below in detail with reference to the accompanying drawings and in combination with the embodiments.

Features, principles and other aspects of the present disclosure are described below in detail.

An optical imaging lens assembly according to an exemplary implementation of the present disclosure may include a lens barrel and a lens group and at least one spacing element that are accommodated in the lens barrel. The lens group may be a group of six lenses, including a first lens, a second lens, a third lens, a fourth lens, a fifth lens and a sixth lens that are sequentially arranged along an optical axis from an object side to an image side.

In an exemplary implementation, the positive and negative signs of the refractive powers of the first lens and the fifth lens are the same. The positive and negative signs of the refractive powers of the second lens, the third lens, the fourth lens and the sixth lens are the same, and are opposite to the positive and negative signs of the refractive power of the first lens.

In an exemplary implementation, the first lens may have a negative refractive power, an object-side surface of the first lens may be a convex surface, and an image-side surface of the first lens may be a concave surface. The second lens may have a positive refractive power, an object-side surface of the second lens may be a convex surface, and an image-side surface of the second lens may be a concave surface. The third lens may have a positive refractive power, an object-side surface of the third lens may be a convex surface, and an image-side surface of the third lens may be a convex surface. The fourth lens may have a positive refractive power, an object-side surface of the fourth lens may be a convex surface, and an image-side surface of the fourth lens may be a convex surface. The fifth lens may have a negative refractive power, an object-side surface of the fifth lens may be a concave surface, and an image-side surface of the fifth lens may be a concave surface or convex surface. The sixth lens may have a positive refractive power, an object-side surface of the sixth lens may be a convex surface, and an image-side surface of the sixth lens may be a concave surface or convex surface.

In an exemplary implementation, the at least one spacing element in the lens assembly may include: a first spacing element, positioned between the first lens and the second lens and in direct contact with the image-side surface of the first lens.

In an exemplary implementation, the optical imaging lens assembly of the present disclosure may satisfy the conditional expression: 0<(D0s−d0s)/(EPD×tan(Semi-FOV))≤0.5. Here, D0s is an outer diameter of an object-side end surface of the lens barrel (the outer diameter of the end surface of the lens barrel closest to the object side that is closest to the object side), dos is an inner diameter of the object-side end surface of the lens barrel (the inner diameter of the end surface of the lens barrel closest to the object side that is closest to the object side), EPD is an entrance pupil diameter of the optical imaging lens assembly, and Semi-FOV is half of a maximal field-of-view of the optical imaging lens assembly.

In an exemplary implementation, the optical imaging lens assembly of the present disclosure may satisfy the conditional expression: 2.0<d1m/(R2×N1)<3.0. Here, d1m is an inner diameter of an image-side surface of the first spacing element, R2 is a radius of curvature of the image-side surface of the first lens, and N1 is a refractive index of the first lens.

An optical imaging lens assembly according to an implementation of the present disclosure includes a lens barrel, and a group of six lenses and at least one spacing element that are accommodated in the lens barrel. The first to sixth lenses are sequentially arranged along an optical axis from an object side to an image side. The first lens has a negative refractive power, an object-side surface of the first lens is a convex surface, and an image-side surface of the first lens is a concave surface. The second lens has a positive refractive power, an object-side surface of the second lens is a convex surface, and an image-side surface of the second lens is a concave surface. The third lens has a positive refractive power, an object-side surface of the third lens is a convex surface, and an image-side surface of the third lens is a convex surface. The fourth lens has a positive refractive power, an object-side surface of the fourth lens is a convex surface, and an image-side surface of the fourth lens is a convex surface. The fifth lens has a negative refractive power, and an object-side surface of the fifth lens is a concave surface. The sixth lens has a positive refractive power, and an object-side surface of the sixth lens is a convex surface. There is a first spacing element in direct contact with the image-side surface of the first lens disposed between the first lens and the second lens. Through such setting of the lens assembly, and by controlling an outer diameter D0s of an object-side end surface of the lens barrel, an inner diameter dos of the object-side end surface of the lens barrel, an entrance pupil diameter EPD of the optical imaging lens assembly and half of a maximal field-of-view Semi-FOV of the optical imaging lens assembly to satisfy the conditional expression 0<(D0s−d0s)/(EPD×tan(Semi-FOV))≤0.5, and at the same time, controlling an inner diameter dim of an image-side surface of the first spacing element, a radius of curvature R2 of the image-side surface of the first lens and a refractive index N1 of the first lens to satisfy the conditional expression 2.0<d1m/(R2×N1)<3.0, the field-of-view of the optical system can be within the design requirements. Meanwhile, through the radius of curvature and refractive index of the first lens, the angle of the incident light can be adjusted, which makes the angle of the light more gentle, thereby obtaining a larger amount of light. On this basis, the stray light generated at the edge of the second lens can further be weakened.

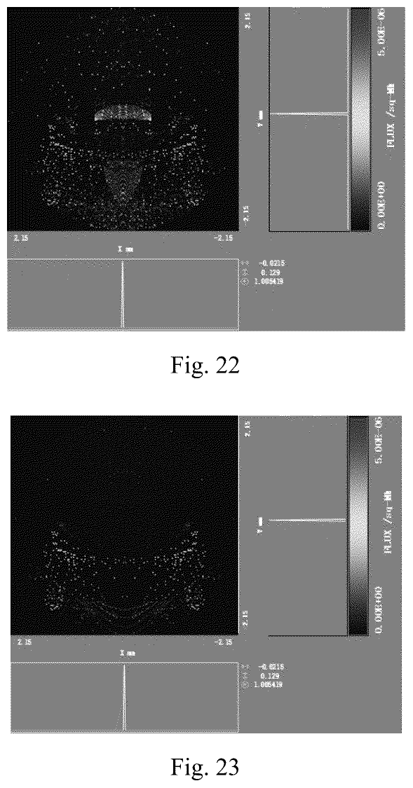

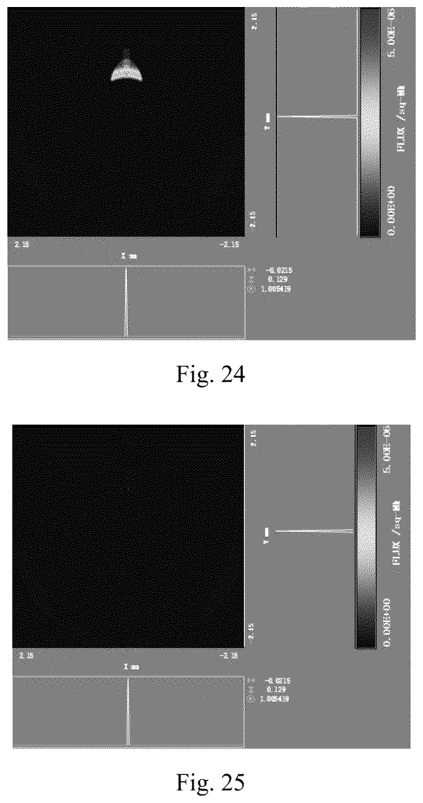

Table A below shows a stray light simulation test of the optical imaging lens assembly according to an exemplary implementation. The stray light simulation test results of the optical imaging lens assembly under three different schemes (Sample 1, Sample 2 and Sample 3) are specifically given in Table A. According to the optical imaging lens assemblies under the three different schemes (Sample 1, Sample 2 and Sample 3), for each optical imaging lens assembly, the outer diameter D0s of the object-side end surface of the lens barrel, the inner diameter dos of the object-side end surface of the lens barrel, the entrance pupil diameter EPD of the optical imaging lens assembly and the half of the maximal field-of-view Semi-FOV of the optical imaging lens assembly satisfy the conditional expression 0<(D0s−d0s)/(EPD×tan(Semi-FOV))≤0.5. On this basis, according to the optical imaging lens assemblies under the three different schemes, for each optical imaging lens assembly, the relational expression d1m/(R2×N1) among the inner diameter dim of the image-side surface of the first spacing element, the radius of curvature R2 of the image-side surface of the first lens and the refractive index N1 of the first lens satisfies a different conditional expression. Specifically, for the lens assembly according to Sample 1, d1m/(R2×N1)=1.56, the spot diagram of the lens assembly under the stray light simulation test is as shown in FIG. 22, and the test result is unqualified. For the lens assembly according to Sample 2, d1m/(R2×N1)=2.39, the spot diagram of the lens assembly under the stray light simulation test is as shown in FIG. 23 and FIG. 25, and the test result is qualified. For the lens assembly according to Sample 3, d1m/(R2×N1)=3.01, the spot diagram of the lens assembly under the stray light simulation test is as shown in FIG. 24, and the test result is unqualified.

It can be seen from the test results of the above three different schemes, for the optical imaging lens assembly according to the exemplary implementation, under the premise that the outer diameter D0s of the object-side end surface of the lens barrel, the inner diameter dos of the object-side end surface of the lens barrel, the entrance pupil diameter EPD of the optical imaging lens assembly and the half of the maximal field-of-view Semi-FOV of the optical imaging lens assembly satisfy the conditional expression 0<(D0s−d0s)/(EPD×tan(Semi-FOV))≤0.5, the lens assembly may have better performance in the stray light simulation test and thus can reach the qualified standard when the numerical value of the relational expression d1m/(R2×N1) among the inner diameter d1m of the image-side surface of the first spacing element of the lens assembly, the radius of curvature R2 of the image-side surface of the first lens and the refractive index N1 of the first lens is greater than 2.0 and less than 3.0. However, the lens assembly has poor performance in the stray light simulation test and thus cannot reach the qualified standard when the numerical value of the relational expression d1m/(R2×N1) among the inner diameter d1m of the image-side surface of the first spacing element of the lens assembly, the radius of curvature R2 of the image-side surface of the first lens and the refractive index N1 of the first lens is less than 2.0 or greater than 3.0. Therefore, by controlling the optical imaging lens assembly to satisfy the conditional expressions 0<(D0s−d0s)/(EPD×tan(Semi-FOV))≤0.5 and 2.0<d1m/(R2×N1)<3.0 in the present disclosure, the field-of-view of the optical system can be within the design requirements. Meanwhile, the angle of the incident light can be adjusted, which makes the angle of the light more gentle, thereby obtaining a larger amount of light. On this basis, the stray light generated at the edge of the second lens can further be weakened.

TABLE A
stray light simulation test

| condition | 0 < (D0s-d0s)/(EPD × tan(Semi-FOV)) ≤ 0.5 | | |
|---|---|---|---|
| sample | Sample 1 | Sample 2 | Sample 3 |
| | d1m/(R2 × N1) = 1.56 | d1m/(R2 × N1) = 2.39 | d1m/(R2 × N1) = 3.01 |
| spot diagram | FIG. 22 | FIG. 23 and FIG. 25 | FIG. 24 |
| state | unqualified | qualified | unqualified |

In an exemplary implementation, the spacing element in the optical imaging lens assembly may further include: a second spacing element, positioned between the second lens and the third lens and in direct contact with the image-side surface of the second lens; a third spacing element, positioned between the third lens and the fourth lens and in direct contact with the image-side surface of the third lens; a fourth spacing element, positioned between the fourth lens and the fifth lens and in direct contact with the image-side surface of the fourth lens; and a fifth spacing element, positioned between the fifth lens and the sixth lens and in direct contact with an image-side surface of the fifth lens.

In an exemplary implementation, a hole is provided at the center of any spacing element, and light can pass through the center hole.

In an exemplary implementation, the optical imaging lens assembly of the present disclosure may satisfy the conditional expression −15.0<V1×(EP01+CP1)/(f1×R1)<−10.5. Here, V1 is an abbe number of the first lens, EP01 is a distance from the object-side end surface of the lens barrel (i.e., the end surface or the surface of the lens barrel closest to the object side) to an object-side surface of the first spacing element on the optical axis, CP1 is a maximal thickness of the first spacing element (i.e., CP1 may be the maximal thickness of the first spacing element in the direction along the optical axis or in the direction parallel to the optical axis), f1 is an effective focal length of the first lens, and R1 is a radius of curvature of the object-side surface of the first lens. By controlling the abbe number of the first lens, the distance from the object-side end surface of the lens barrel to the object-side surface of the first spacing element on the optical axis, the maximal thickness of the first spacing element, the effective focal length of the first lens and the radius of curvature of the object-side surface of the first lens to satisfy the conditional expression-15.0<V1×(EP01+CP1)/(f1×R1)<−10.5, the processability of the first lens can be better, thus obtaining a lens surface type closer to the theoretical surface type. Accordingly, the light adjustment capability is improved, thus obtaining a larger light incident angle.

In an exemplary implementation, the optical imaging lens assembly of the present disclosure may satisfy the conditional expression 0.3<(DT11−DT12)/(D1s−d1s)<1.3. Here, DT11 is a maximal effective radius of the object-side surface of the first lens, DT12 is a maximal effective radius of the image-side surface of the first lens, D1s is an outer diameter of the object-side surface of the first spacing element, and d1s is an inner diameter of the object-side surface of the first spacing element. By controlling the maximal effective radius of the object-side surface of the first lens, the maximal effective radius of the image-side surface of the first lens, the outer diameter of the object-side surface of the first spacing element and the inner diameter of the object-side surface of the first spacing element to satisfy the conditional expression 0.3<(DT11−DT12)/(D1s−d1s)<1.3, the height of the light passing through the first lens can be controlled, thereby reducing the generation of edge stray light. Meanwhile, by controlling the inner and outer diameters of the first spacing element, the diameter-to-thickness ratio of the lens can be reasonably controlled, which is conducive to molding. Through the inner diameter, the angle of the incident light can be adjusted, thereby reducing the stray light.

In an exemplary implementation, the optical imaging lens assembly of the present disclosure may satisfy the conditional expression 6.0<D2s/DT22<10.5. Here, D2s is an outer diameter of an object-side surface of the second spacing element, and DT22 is a maximal effective radius of the image-side surface of the second lens. By controlling the ratio of the outer diameter of the object-side surface of the second spacing element to the maximal effective radius of the image-side surface of the second lens within this range, the diameter-to-thickness ratio of the third lens can be reasonably controlled. Meanwhile, the degree of light convergence at the diaphragm can be reasonably controlled in combination with the effective radius parameter of the second lens, such that the illumination of the system is within the design requirements.

In an exemplary implementation, the optical imaging lens assembly of the present disclosure may satisfy the conditional expression 4.5 mm<|R3×f2|/(N2+CT2+EP12)<8.5 mm. Here, R3 is a radius of curvature of the object-side surface of the second lens, f2 is an effective focal length of the second lens, N2 is a refractive index of the second lens, CT2 is a center thickness of the second lens on the optical axis, and EP12 is a distance from the image-side surface of the first spacing element to an object-side surface of the second spacing element on the optical axis. By controlling the radius of curvature of the object-side surface of the second lens, the effective focal length of the second lens, the refractive index of the second lens, the center thickness of the second lens on the optical axis and the distance from the image-side surface of the first spacing element to the object-side surface of the second spacing element on the optical axis to satisfy the conditional expression 4.5 mm<|R3×f2|/(N2+CT2+EP12)<8.5 mm, the thickness ratio data of the second lens can be within a reasonable processing range, and at the same time, the capability of the second lens to balance the aberration can be more outstanding.

In an exemplary implementation, the optical imaging lens assembly of the present disclosure may satisfy the conditional expression −0.2<(T34−CP3)×V3/f3<1.0. Here, T34 is an air spacing between the third lens and the fourth lens on the optical axis, CP3 is a maximal thickness of the third spacing element (i.e., CP3 may be the maximal thickness of the third spacing element in the direction along the optical axis or in the direction parallel to the optical axis), V3 is an abbe number of the third lens, and f3 is an effective focal length of the third lens. By controlling the air spacing between the third lens and the fourth lens on the optical axis, the maximal thickness of the third spacing element, the abbe number of the third lens, and the effective focal length of the third lens to satisfy the conditional expression −0.2<(T34−CP3)×V3/f3<1.0, the effective light passing through the third lens can obtain a reasonable divergence angle, which reduces the generation of edge stray light, and at the same time, which is conducive to obtaining a larger image plane parameter.

In an exemplary implementation, the optical imaging lens assembly of the present disclosure may satisfy the conditional expression 1.0<D3s/R6+D3m/R7<4.0. Here, D3s is an outer diameter of an object-side surface of the third spacing element, R6 is a radius of curvature of the image-side surface of the third lens, D3m is an outer diameter of an image-side surface of the third spacing element, and R7 is a radius of curvature of the object-side surface of the fourth lens. By controlling the outer diameter of the object-side surface of the third spacing element, the radius of curvature of the image-side surface of the third lens, the outer diameter of the image-side surface of the third spacing element and the radius of curvature of the object-side surface of the fourth lens to satisfy the conditional expression 1.0<D3s/R6+D3m/R7<4.0, the system can have a larger aperture, making the brightness of the system greater. Meanwhile, through a reasonable setting of the outer diameter of the spacer, the spacer gradient can also be distinguished, to automatically prevent errors.

In an exemplary implementation, the optical imaging lens assembly of the present disclosure may satisfy the conditional expression 0<(EP34+CP4)/(f4×N4)<0.3. Here, EP34 is a distance from the image-side surface of the third spacing element to an object-side surface of the fourth spacing element on the optical axis, CP4 is a maximal thickness of the fourth spacing element (i.e., CP4 may be the maximal thickness of the fourth spacing element in the direction along the optical axis or in the direction parallel to the optical axis), f4 is an effective focal length of the fourth lens, and N4 is a refractive index of the fourth lens. By controlling the distance from the image-side surface of the third spacing element to the object-side surface of the fourth spacing element on the optical axis, the maximal thickness of the fourth spacing element, the effective focal length of the fourth lens and the refractive index of the fourth lens to satisfy the conditional expression 0<(EP34+CP4)/(f4×N4)<0.3, the deflection angle of the edge light passing through the fourth lens can be effectively controlled, and at the same time, the sensitivity of the system can be effectively reduced in combination with other parameters.

In an exemplary implementation, the optical imaging lens assembly of the present disclosure may satisfy the conditional expression −1.0<(d5s−d4m)/R10<0.5. Here, d5s is an inner diameter of an object-side surface of the fifth spacing element, d4m is an inner diameter of an image-side surface of the fourth spacing element, and R10 is a radius of curvature of the image-side surface of the fifth lens. By controlling the inner diameter of the object-side surface of the fifth spacing element, the inner diameter of the image-side surface of the fourth spacing element and the radius of curvature of the image-side surface of the fifth lens to satisfy the conditional expression −1.0<(d5s−d4m)/R10<0.5, the ineffective edge light can be effectively filtered out, thereby reducing the generation of stray light spots. Meanwhile, the astigmatism of the optical imaging lens assembly can be effectively balanced in combination with the radius of curvature of the fifth lens, which further ensures the miniaturization of the optical imaging lens assembly.

In an exemplary implementation, the optical imaging lens assembly of the present disclosure may satisfy the conditional expression 3.5<D5m/DT61<5.0. Here, D5m is an outer diameter of an image-side surface of the fifth spacing element, and DT61 is a maximal effective radius of the object-side surface of the sixth lens. By controlling the ratio of the outer diameter of the image-side surface of the fifth spacing element to the maximal effective radius of the object-side surface of the sixth lens within this range, the mismatch discrepancy between the sixth lens and the fifth lens can be effectively controlled, which improves the stability of assembling, thereby further improving the yield rate. Meanwhile, through the effective radius parameter of the sixth lens, the emitted light can be reasonably controlled, thereby obtaining the image plane size and illumination required by the design.

In an exemplary implementation, the optical imaging lens assembly of the present disclosure may satisfy the conditional expression-0.2<(EP45+CP5+CT5)/R12<1.0. Here, EP45 is a distance from the image-side surface of the fourth spacing element to the object-side surface of the fifth spacing element on the optical axis, CP5 is a maximal thickness of the fifth spacing element (i.e., CP5 may be the maximal thickness of the fifth spacing element in the direction along the optical axis or in the direction parallel to the optical axis), CT5 is a center thickness of the fifth lens on the optical axis, and R12 is a radius of curvature of an image-side surface of the sixth lens. By controlling the distance from the image-side surface of the fourth spacing element to the object-side surface of the fifth spacing element on the optical axis, the maximal thickness of the fifth spacing element, the center thickness of the fifth lens on the optical axis and the radius of curvature of the image-side surface of the sixth lens to satisfy the conditional expression −0.2<(EP45+CP5+CT5)/R12<1.0, the size of the group of the fifth lens and the sixth lens can be reasonably controlled, such that the lens assembly can be further miniaturized. Meanwhile, it helps to make the size distribution of the lenses even, which ensures the stability of assembling and reduces the aberrations of the entire imaging system.

In an exemplary implementation, the optical imaging lens assembly of the present disclosure may include at least one diaphragm. The diaphragm may constrain the light path and control the light intensity. The diaphragm may be disposed at an appropriate position of the optical imaging lens assembly. For example, the diaphragm may be disposed between the second lens and the third lens.

In an exemplary implementation, optionally, the above optical imaging lens assembly may further include an optical filter for correcting color deviations and/or a protective glass for protecting a photosensitive element on the image plane.

In an exemplary implementation, there may be one or more aspheric surfaces among the surfaces of the first lens, the second lens, the third lens, the fourth lens, the fifth lens and the sixth lens. An aspheric surface has a better radius-of-curvature characteristic, and has advantages of improving the distortion aberration and the astigmatic aberration. The use of the aspheric surface can eliminate as much as possible the aberrations that occur during the imaging, thereby improving the imaging quality.

An optical imaging lens assembly according to an implementation of the present disclosure includes a lens barrel, and a group of six lenses and at least one spacing element that are accommodated in the lens barrel. The first to sixth lenses are sequentially arranged along an optical axis from an object side to an image side. The positive and negative signs of the refractive powers of the first lens and the fifth lens are the same. The positive and negative signs of the refractive powers of the second lens, the third lens, the fourth lens and the sixth lens are the same, and are opposite to the positive and negative signs of the refractive power of the first lens. There is a first spacing element in direct contact with an image-side surface of the first lens disposed between the first lens and the second lens. Through such setting of the lens assembly, and by controlling an outer diameter D0s of an object-side end surface of the lens barrel, an inner diameter dos of the object-side end surface of the lens barrel, an entrance pupil diameter EPD of the optical imaging lens assembly and half of a maximal field-of-view Semi-FOV of the optical imaging lens assembly to satisfy the conditional expression 0<(D0s−d0s)/(EPD×tan(Semi-FOV))≤0.5, and at the same time, controlling an inner diameter d1m of an image-side surface of the first spacing element, a radius of curvature R2 of the image-side surface of the first lens and a refractive index N1 of the first lens to satisfy the conditional expression 2.0<d1m/(R2×N1)<3.0, the field-of-view of the optical system can be within the design requirements. Meanwhile, through the radius of curvature and refractive index of the first lens, the angle of the incident light can be adjusted, which makes the angle of the light more gentle, thereby obtaining a larger amount of light. On this basis, the stray light generated at the edge of the second lens can further be weakened.

In an other aspect, an optical imaging lens assembly according to an implementation of the present disclosure includes a lens, barrel and a group of six lenses and at least one spacing element that are accommodated in the lens barrel. The first to sixth lenses are sequentially arranged along an optical axis from an object side to an image side. The positive and negative signs of the refractive powers of the first lens and the fifth lens are the same. The positive and negative signs of the refractive powers of the second lens, the third lens, the fourth lens and the sixth lens are the same, and are opposite to the positive and negative signs of the refractive power of the first lens. There is a first spacing element in direct contact with an image-side surface of the first lens disposed between the first lens and the second lens. Through such setting of the lens assembly, and by controlling a radius of curvature R3 of an object-side surface of the second lens, an effective focal length f2 of the second lens, a refractive index N2 of the second lens, a center thickness CT2 of the second lens on the optical axis and a distance EP12 from the image-side surface of the first spacing element to an object-side surface of a second spacing element on the optical axis to satisfy the conditional expression 4.5 mm<|R3×f2|/(N2+CT2+EP12)<8.5 mm, the thickness ratio data of the second lens can be within a reasonable processing range, and at the same time, the capability of the second lens to balance the aberration can be more outstanding.

In an other aspect, an optical imaging lens assembly according to an implementation of the present disclosure includes a lens barrel, and a group of six lenses and at least one spacing element that are accommodated in the lens barrel. The first to sixth lenses are sequentially arranged along an optical axis from an object side to an image side. The positive and negative signs of the refractive powers of the first lens and the fifth lens are the same. The positive and negative signs of the refractive powers of the second lens, the third lens, the fourth lens and the sixth lens are the same, and are opposite to the positive and negative signs of the refractive power of the first lens. There is a first spacing element in direct contact with an image-side surface of the first lens disposed between the first lens and the second lens. Through such setting of the lens assembly, and by controlling a distance EP34 from an image-side surface of a third spacing element to an object-side surface of a fourth spacing element on the optical axis, a maximal thickness CP4 of the fourth spacing element, an effective focal length f4 of the fourth lens and a refractive index N4 of the fourth lens to satisfy the conditional expression 0<(EP34+CP4)/(f4×N4)<0.3, the deflection angle of the edge light passing through the fourth lens can be effectively controlled, and at the same time, the sensitivity of the system can be effectively reduced in combination with other parameters.

In an other aspect, an optical imaging lens assembly according to an implementation of the present disclosure includes a lens barrel, and a group of six lenses and at least one spacing element that are accommodated in the lens barrel. The first to sixth lenses are sequentially arranged along an optical axis from an object side to an image side. The positive and negative signs of the refractive powers of the first lens and the fifth lens are the same. The positive and negative signs of the refractive powers of the second lens, the third lens, the fourth lens and the sixth lens are the same, and are opposite to the positive and negative signs of the refractive power of the first lens. There is a first spacing element in direct contact with an image-side surface of the first lens disposed between the first lens and the second lens. Through such setting of the lens assembly, and by controlling a distance EP45 from an image-side surface of a fourth spacing element to an object-side surface of a fifth spacing element on the optical axis, a maximal thickness CP5 of the fifth spacing element, a center thickness CT5 of the fifth lens on the optical axis and a radius of curvature R12 of an image-side surface of the sixth lens to satisfy the conditional expression −0.2<(EP45+CP5+CT5)/R12<1.0, the size of the group of the fifth lens and the sixth lens can be reasonably controlled, such that the lens assembly can be further miniaturized. Meanwhile, it helps to make the size distribution of the lenses even, which ensures the stability of assembling and reduces the aberrations of the entire imaging system.

However, it should be understood by those skilled in the art that the various results and advantages described in the present specification may be obtained by changing the number of the lenses constituting the optical imaging lens assembly or by changing the number of the spacing elements without departing from the technical solution claimed by the present disclosure, which is not specifically limited in the present disclosure. As an example, although the optical imaging lens assembly having six lenses is described as an example in the implementations, the optical imaging lens assembly is not limited to including the six lenses. If desired, the optical imaging lens assembly may alternatively include other numbers of lenses. As another example, if desired, the optical imaging lens assembly may alternatively include other numbers of spacing elements different from those described in the above implementations.

Specific embodiments of the optical imaging lens assembly that may be applicable to the above implementations are further described below with reference to the accompanying drawings.

### Embodiment 1

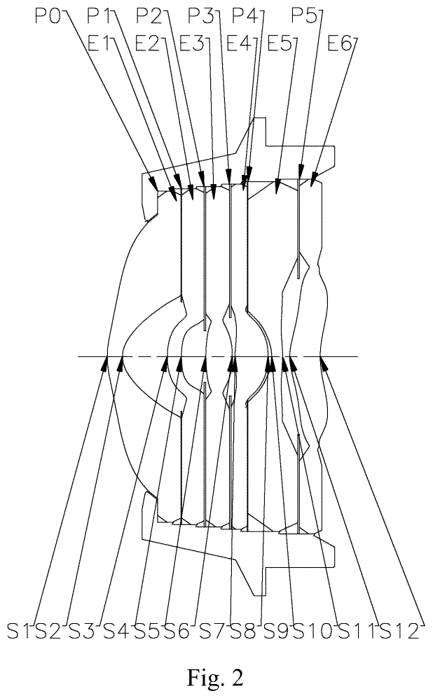

An optical imaging lens assembly according to Embodiment 1 of the present disclosure is described below with reference to FIG. 2.

As shown in FIG. 2, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side.

In this embodiment, the optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

In this embodiment, the first lens E1 has a negative refractive power, an object-side surface S1 of the first lens E1 is a convex surface, and the image-side surface S2 of the first lens E1 is a concave surface. The second lens E2 has a positive refractive power, an object-side surface S3 of the second lens E2 is a convex surface, and the image-side surface S4 of the second lens E2 is a concave surface. The third lens E3 has a positive refractive power, an object-side surface S5 of the third lens E3 is a convex surface, and the image-side surface S6 of the third lens E3 is a convex surface. The fourth lens E4 has a positive refractive power, an object-side surface S7 of the fourth lens E4 is a convex surface, and the image-side surface S8 of the fourth lens E4 is a convex surface. The fifth lens E5 has a negative refractive power, an object-side surface S9 of the fifth lens E5 is a concave surface, and the image-side surface S10 of the fifth lens E5 is a convex surface. The sixth lens E6 has a positive refractive power, an object-side surface S11 of the sixth lens E6 is a convex surface, and an image-side surface S12 of the sixth lens E6 is a concave surface.

In this embodiment, the optical imaging lens assembly may further include, for example, an optical filter (not shown) positioned on the image side of the sixth lens E6 and having an object-side surface S13 and an image-side surface S14, and an image plane S15 (not shown) positioned on the image side of optical filter. For example, light from an object may sequentially pass through the surfaces S1-S14, and finally form an image on the image plane S15.

Table 1 shows basic parameters of the optical imaging lens assembly of Embodiment 1. Here, the units of a radius of curvature and a thickness/distance are millimeters (mm).

TABLE 1

| | | | | material | | |
|---|---|---|---|---|---|---|
| surface | surface | radius of | thickness/ | refractive | abbe | conic |
| number | type | curvature | distance | index | number | coefficient |
| OBJ | spherical | infinite | 300.0000 | | | |
| S1 | aspheric | 1.8501 | 0.3750 | 1.53 | 55.7 | −1.0000 |
| S2 | aspheric | 0.6292 | 1.0983 | | | −1.2787 |
| S3 | aspheric | 1.7266 | 0.3464 | 1.64 | 23.5 | 0.0000 |
| S4 | aspheric | 2.4608 | 0.5988 | | | 0.0000 |
| STO | spherical | infinite | 0.0000 | | | |
| S5 | aspheric | 3.6817 | 0.6484 | 1.54 | 56.0 | 0.0000 |
| S6 | aspheric | −3.5068 | 0.0699 | | | 0.0000 |
| S7 | aspheric | 2.0777 | 0.8112 | 1.54 | 56.0 | 0.0000 |
| S8 | aspheric | −1.6088 | 0.0877 | | | 0.0000 |
| S9 | aspheric | −0.9040 | 0.2669 | 1.66 | 20.3 | −1.0000 |
| S10 | aspheric | −3.0359 | 0.1747 | | | 0.0000 |
| S11 | aspheric | 1.2537 | 0.7476 | 1.53 | 55.7 | −1.0000 |
| S12 | aspheric | 2.2964 | 0.5497 | | | 0.0000 |
| S13 | spherical | infinite | 0.2100 | 1.51 | 64.1 | |
| S14 | spherical | infinite | 0.2722 | | | |
| S15 | spherical | infinite | | | | |

In Embodiment 1, the object-side surface and the image-side surface of any lens in the first to sixth lenses E1-E6 are both aspheric surfaces, and the surface type x of each aspheric lens may be defined using, but not limited to, the following formula:

$$x = \frac{{ch}^{2}}{1 + \sqrt{1 - ( k + 1 ) {c}^{2} {h}^{2}}} + \sum {Aih}^{i} . \qquad ( 1 )$$

Here, X is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of the i-th order of the aspheric surface. Table 2-1 and table 2-2 below show the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in Embodiment 1.

TABLE 2-1

| surface | | | | | | | |
|---|---|---|---|---|---|---|---|
| number | A4 | A6 | A8 | A10 | A12 | A14 | A16 |
| S1 | −2.27E+00 | 6.32E−01 | −1.96E−01 | 7.94E−02 | −3.47E−02 | 1.63E−02 | −7.50E−03 |
| S2 | 4.18E−02 | 3.79E−02 | −3.00E−03 | 5.07E−03 | −2.84E−03 | −2.63E−03 | −1.45E−03 |
| S3 | 1.79E−01 | −1.03E−02 | −2.07E−02 | −8.74E−03 | −1.17E−03 | 1.09E−03 | 8.76E−04 |
| S4 | 1.83E−01 | 2.81E−02 | 4.54E−03 | −1.75E−04 | −6.12E−04 | −3.31E−04 | −9.29E−05 |
| S5 | 2.24E−02 | 3.22E−03 | 5.36E−04 | 1.33E−05 | −1.85E−05 | −4.61E−06 | −1.24E−06 |
| S6 | −1.50E−01 | 3.43E−02 | −2.27E−03 | 2.62E−03 | −5.95E−04 | 1.37E−04 | −6.13E−05 |
| S7 | −2.81E−01 | 3.25E−02 | −5.54E−03 | 4.63E−03 | −9.83E−04 | −6.44E−05 | −2.95E−04 |
| S8 | −1.45E−01 | 1.88E−02 | 1.06E−02 | 4.98E−03 | 3.91E−03 | −8.08E−04 | 4.55E−04 |
| S9 | 1.26E−01 | −5.27E−02 | 1.49E−02 | −1.77E−04 | 2.57E−03 | −1.60E−03 | 1.07E−03 |
| S10 | 4.05E−01 | −7.52E−02 | 1.31E−02 | −7.68E−04 | −9.62E−04 | 5.45E−05 | 6.43E−04 |
| S11 | −1.43E+00 | 3.14E−01 | −7.32E−02 | 2.46E−02 | −9.43E−03 | 3.05E−03 | −7.39E−04 |
| S12 | −1.22E+00 | 1.58E−02 | −3.65E−03 | 6.19E−03 | 4.36E−03 | −1.52E−03 | −3.40E−05 |

TABLE 2-2

| surface | | | | | | | |
|---|---|---|---|---|---|---|---|
| number | A18 | A20 | A22 | A24 | A26 | A28 | A30 |
| S1 | 3.61E−03 | −1.74E−03 | 8.08E−04 | −4.02E−04 | 1.46E−04 | −5.69E−05 | 1.67E−05 |
| S2 | −4.31E−04 | 0.00E+00 | 0.00E+00 | 0.00E+00 | 0.00E+00 | 0.00E+00 | 0.00E+00 |
| S3 | 2.63E−04 | −7.08E−05 | −1.26E−04 | −7.16E−05 | −1.66E−05 | 5.26E−06 | 3.70E−06 |
| S4 | −1.07E−06 | 2.48E−05 | 1.12E−05 | 1.70E−06 | −3.92E−06 | −6.94E−07 | −8.09E−07 |
| S5 | −1.35E−06 | 0.00E+00 | 0.00E+00 | 0.00E+00 | 0.00E+00 | 0.00E+00 | 0.00E+00 |
| S6 | 6.74E−05 | 1.01E−05 | 7.08E−06 | −5.75E−06 | −1.75E−07 | 7.51E−07 | 1.11E−06 |
| S7 | 1.09E−04 | 6.77E−05 | 6.44E−05 | 3.93E−06 | −3.46E−06 | −1.04E−05 | −4.82E−06 |
| S8 | −5.07E−04 | −2.73E−04 | −5.21E−06 | −4.16E−06 | −1.13E−06 | −2.87E−07 | −6.65E−08 |
| S9 | −2.97E−04 | −7.06E−05 | 3.93E−05 | −1.24E−05 | −8.52E−06 | −7.15E−06 | −2.38E−06 |
| S10 | −6.41E−04 | 3.56E−04 | −1.29E−04 | 2.10E−05 | 0.00E+00 | 0.00E+00 | 0.00E+00 |
| S11 | 2.75E−04 | −2.64E−04 | 1.46E−04 | −2.92E−05 | 0.00E+00 | 0.00E+00 | 0.00E+00 |
| S12 | −2.71E−04 | 9.40E−05 | −3.20E−05 | 4.87E−06 | −7.33E−07 | 0.00E+00 | 0.00E+00 |

### Embodiment 2

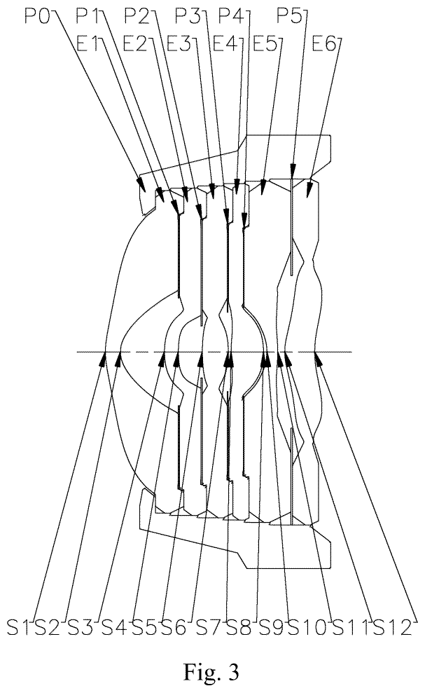

An optical imaging lens assembly according to Embodiment 2 of the present disclosure is described below with reference to FIG. 3.

As shown in FIG. 3, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side. The optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

The structure of the optical imaging lens assembly in this embodiment is the same as that of the optical imaging lens assembly in Embodiment 1, that is, the table of the basic parameters of the optical imaging lens assembly in this embodiment is the same as Table 1, and the tables of the high-order coefficients of the aspheric surfaces are the same as Table 2-1 and Table 2-2.

This embodiment differs from Embodiment 1 in that the structure sizes of the lens barrels and the spacing elements and the spacing distances between some of the spacing elements along the direction of the optical axis are different. The numerical values of a plurality of parameters of the lens barrels and the spacing elements included in the optical imaging lens assemblies in this embodiment and Embodiment 1 are as shown in the following Table 9. The plurality of parameters include the following.

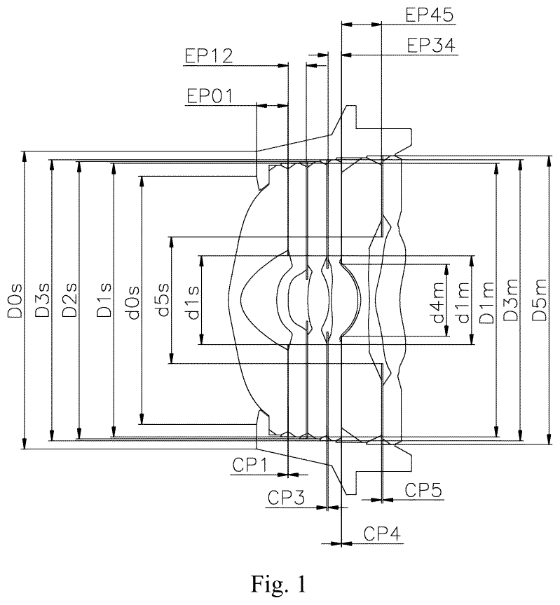

An inner diameter d1s of an object-side surface of the first spacing element P1, an inner diameter dm of an image-side surface of the first spacing element P1, an outer diameter D1s of the object-side surface of the first spacing element P1, an outer diameter D2s of an object-side surface of the second spacing element P2, an outer diameter D3s of an object-side surface of the third spacing element P3, an outer diameter D3m of an image-side surface of the third spacing element P3, an inner diameter d4m of an image-side surface of the fourth spacing element P4, an inner diameter d5s of an object-side surface of the fifth spacing element P5, an outer diameter D5m of an image-side surface of the fifth spacing element P5, an outer diameter D0s of an object-side end surface of the lens barrel P0, an inner diameter dos of the object-side end surface of the lens barrel P0, a distance EP01 from the object-side end surface of the lens barrel P0 to the object-side surface of the first spacing element P1 on the optical axis, a spacing distance EP12 between the first spacing element P1 and the second spacing element P2 on the optical axis, a spacing distance EP34 between the third spacing element P3 and the fourth spacing element P4 on the optical axis, a spacing distance EP45 between the fourth spacing element P4 and the fifth spacing element P5 on the optical axis, a maximal thickness CP1 of the first spacing element P1, a maximal thickness CP3 of the third spacing element P3, a maximal thickness CP4 of the fourth spacing element P4, and a maximal thickness CP5 of the fifth spacing element P5. The units of the numerical values of the parameters shown in Table 9 are all millimeters (mm), and the schematic representation of each parameter in the structural diagram of the optical imaging lens assembly is as shown in FIG. 1.

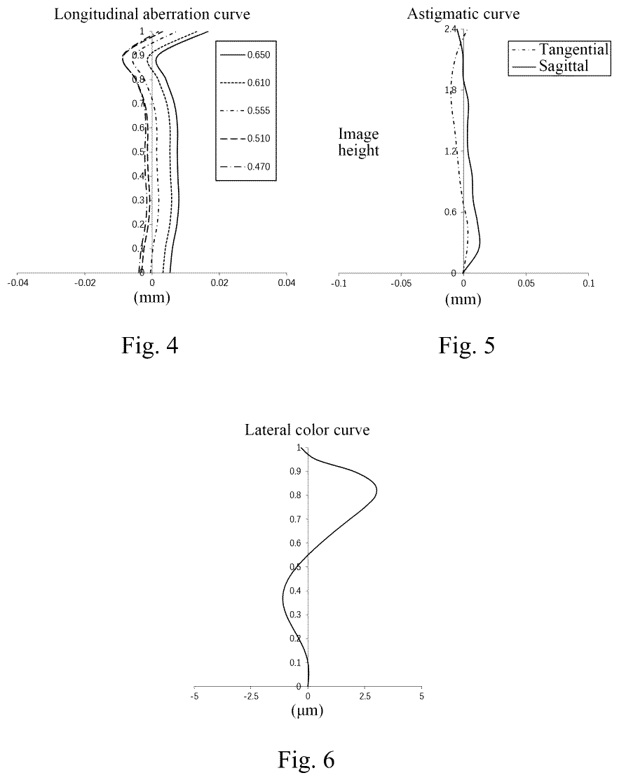

FIG. 4 illustrates a longitudinal aberration curve of the optical imaging lens assemblies of Embodiments 1 and 2, representing deviations of focal points of light of different wavelengths converged after passing through a lens assembly. FIG. 5 illustrates an astigmatic curve of the optical imaging lens assemblies of Embodiments 1 and 2, representing a curvature of a tangential image plane and a curvature of a sagittal image plane. FIG. 6 illustrates a lateral color curve of the optical imaging lens assemblies of Embodiments 1 and 2, representing deviations of different image heights on the image plane after light passes through a lens assembly. It can be seen from FIGS. 4-6 that the optical imaging lens assemblies given in Embodiments 1 and 2 can achieve a good imaging quality.

### Embodiment 3

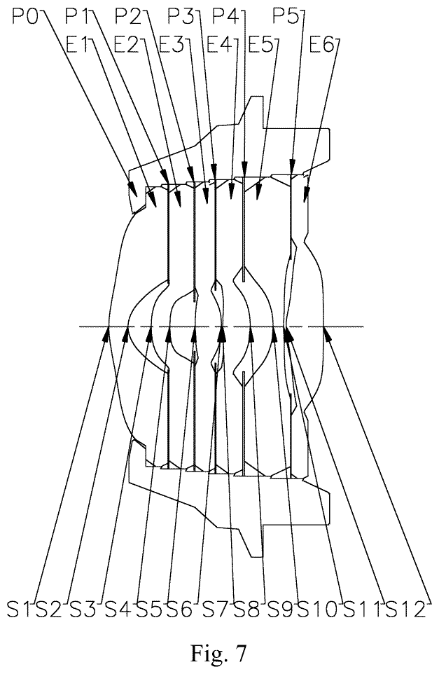

An optical imaging lens assembly according to Embodiment 3 of the present disclosure is described below with reference to FIG. 7.

As shown in FIG. 7, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side.

In this embodiment, the optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

In this embodiment, the first lens E1 has a negative refractive power, an object-side surface S1 of the first lens E1 is a convex surface, and the image-side surface S2 of the first lens E1 is a concave surface. The second lens E2 has a positive refractive power, an object-side surface S3 of the second lens E2 is a convex surface, and the image-side surface S4 of the second lens E2 is a concave surface. The third lens E3 has a positive refractive power, an object-side surface S5 of the third lens E3 is a convex surface, and the image-side surface S6 of the third lens E3 is a convex surface. The fourth lens E4 has a positive refractive power, an object-side surface S7 of the fourth lens E4 is a convex surface, and the image-side surface S8 of the fourth lens E4 is a convex surface. The fifth lens E5 has a negative refractive power, an object-side surface S9 of the fifth lens E5 is a concave surface, and the image-side surface S10 of the fifth lens E5 is a concave surface. The sixth lens E6 has a positive refractive power, an object-side surface S11 of the sixth lens E6 is a convex surface, and an image-side surface S12 of the sixth lens E6 is a convex surface.

In this embodiment, the optical imaging lens assembly may further include, for example, an optical filter (not shown) positioned on the image side of the sixth lens E6 and having an object-side surface S13 and an image-side surface S14, and an image plane S15 (not shown) positioned on the image side of optical filter. For example, light from an object may sequentially pass through the surfaces S1-S14, and finally form an image on the image plane S15.

Table 3 shows basic parameters of the optical imaging lens assembly of Embodiment 3. Here, the units of a radius of curvature and a thickness/distance are millimeters (mm).

TABLE 3

| | | | | material | | |
|---|---|---|---|---|---|---|
| surface | surface | radius of | thickness/ | refractive | abbe | conic |
| number | type | curvature | distance | index | number | coefficient |
| OBJ | spherical | infinite | 300.0000 | | | |
| S1 | aspheric | 2.1584 | 0.4629 | 1.53 | 55.7 | −1.0000 |
| S2 | aspheric | 0.6007 | 0.5600 | | | −1.2204 |
| S3 | aspheric | 2.0415 | 0.4502 | 1.64 | 23.5 | 0.0000 |
| S4 | aspheric | 2.6132 | 0.6116 | | | 0.0000 |
| STO | spherical | infinite | 0.0000 | | | |
| S5 | aspheric | 4.8550 | 0.6341 | 1.54 | 56.0 | 0.0000 |
| S6 | aspheric | −4.4655 | 0.0300 | | | 0.0000 |
| S7 | aspheric | 1.6994 | 0.6699 | 1.54 | 56.0 | 0.0000 |
| S8 | aspheric | −1.9565 | 0.5496 | | | 0.0000 |
| S9 | aspheric | −1.7761 | 0.2511 | 1.66 | 20.3 | 0.0000 |
| S10 | aspheric | 3.5380 | 0.0616 | | | 0.0000 |
| S11 | aspheric | 1.2450 | 0.9050 | 1.53 | 55.7 | −1.0000 |
| S12 | aspheric | −14.7736 | 0.3678 | | | 0.0000 |
| S13 | spherical | infinite | 0.2100 | 1.51 | 64.1 | |
| S14 | spherical | infinite | 0.2722 | | | |
| S15 | spherical | infinite | | | | |

In this embodiment, the object-side surface and the image-side surface of any lens in the first to sixth lenses E1-E6 are both aspheric surfaces, and the surface type of each aspheric surface may be defined using the formula (1) given in Embodiment 1. Table 4-1 and Table 4-2 show the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in this embodiment.

TABLE 4-1

| surface | | | | | | | |
|---|---|---|---|---|---|---|---|
| number | A4 | A6 | A8 | A10 | A12 | A14 | A16 |
| S1 | −1.25E+00 | 3.32E−01 | −7.98E−02 | 2.38E−02 | −7.43E−03 | 4.30E−03 | −2.86E−03 |
| S2 | 6.50E−02 | 9.93E−03 | 1.81E−03 | 4.54E−03 | −7.77E−04 | 1.18E−04 | −4.35E−04 |
| S3 | 2.02E−01 | −7.54E−03 | −1.77E−02 | −6.41E−03 | −1.48E−03 | 4.13E−04 | 3.20E−04 |
| S4 | 1.86E−01 | 2.65E−02 | 3.70E−03 | −5.60E−04 | −4.70E−04 | −2.89E−04 | −1.94E−05 |
| S5 | 9.35E−03 | 1.55E−03 | 1.84E−04 | −1.65E−05 | −2.63E−05 | −7.25E−06 | −1.37E−06 |
| S6 | −2.03E−01 | 4.98E−02 | −9.84E−03 | 5.50E−03 | −2.00E−03 | 6.07E−04 | −4.66E−04 |
| S7 | −3.47E−01 | 6.03E−02 | −1.40E−02 | 9.26E−03 | −3.25E−03 | 1.08E−03 | −7.99E−04 |
| S8 | −1.11E−01 | 4.82E−03 | 5.42E−03 | 3.26E−03 | 1.47E−03 | 1.96E−04 | −7.54E−05 |
| S9 | −7.24E−02 | −5.74E−04 | 5.80E−03 | 5.73E−04 | 1.62E−03 | −1.09E−03 | 3.44E−04 |
| S10 | −2.71E−01 | 8.30E−02 | −2.95E−02 | 1.01E−02 | −1.31E−03 | −1.55E−03 | 1.59E−03 |
| S11 | −1.31E+00 | 3.08E−01 | −9.38E−02 | 2.88E−02 | −8.51E−03 | 2.98E−03 | −1.32E−04 |
| S12 | −2.64E−01 | −5.20E−02 | 3.26E−02 | −8.52E−03 | −1.03E−03 | −6.29E−04 | 1.15E−03 |

TABLE 4-2

| surface | | | | | | | |
|---|---|---|---|---|---|---|---|
| number | A18 | A20 | A22 | A24 | A26 | A28 | A30 |
| S1 | 1.88E−03 | −1.24E−03 | 6.79E−04 | −3.69E−04 | 1.89E−04 | −7.39E−05 | 3.35E−05 |
| S2 | −2.10E−04 | 0.00E+00 | 0.00E+00 | 0.00E+00 | 0.00E+00 | 0.00E+00 | 0.00E+00 |
| S3 | 1.85E−04 | 3.39E−05 | 3.77E−06 | 5.27E−07 | 6.96E−08 | 0.00E+00 | 0.00E+00 |
| S4 | −2.26E−06 | 6.07E−05 | 1.43E−05 | 2.24E−05 | −2.41E−06 | 8.91E−06 | −1.69E−06 |
| S5 | 1.91E−06 | 0.00E+00 | 0.00E+00 | 0.00E+00 | 0.00E+00 | 0.00E+00 | 0.00E+00 |
| S6 | 1.12E−04 | −7.69E−05 | 1.50E−06 | −3.14E−05 | −2.66E−05 | −1.28E−05 | −1.30E−05 |
| S7 | 3.57E−04 | −1.18E−04 | 8.14E−05 | −5.85E−05 | −1.14E−05 | −1.90E−05 | −1.27E−06 |
| S8 | −9.84E−05 | −4.80E−05 | −2.63E−05 | −1.91E−06 | 0.00E+00 | 0.00E+00 | 0.00E+00 |
| S9 | −4.48E−04 | 1.55E−04 | 1.15E−05 | 1.56E−06 | 0.00E+00 | 0.00E+00 | 0.00E+00 |
| S10 | −1.34E−03 | 7.87E−04 | −3.15E−04 | 1.00E−04 | 2.18E−07 | 0.00E+00 | 0.00E+00 |
| S11 | −8.90E−04 | 5.88E−04 | −3.56E−04 | 1.09E−04 | 9.59E−07 | 0.00E+00 | 0.00E+00 |
| S12 | 1.49E−03 | −2.93E−04 | −1.44E−05 | −2.15E−04 | −5.34E−06 | −1.92E−07 | 0.00E+00 |

### Embodiment 4

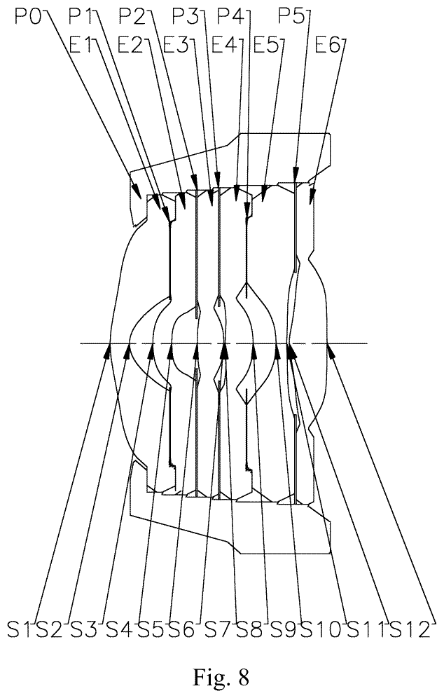

An optical imaging lens assembly according to Embodiment 4 of the present disclosure is described below with reference to FIG. 8.

As shown in FIG. 8, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side. The optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

The structure of the optical imaging lens assembly in this embodiment is the same as that of the optical imaging lens assembly in Embodiment 3, that is, the table of the basic parameters of the optical imaging lens assembly in this embodiment is the same as Table 3, and the tables of the high-order coefficients of the aspheric surfaces are the same as Table 4-1 and Table 4-2.

This embodiment differs from Embodiment 3 in that the structure sizes of the lens barrels and some spacing elements and the spacing distances between some of the spacing elements along the direction of the optical axis are different. The numerical values of a plurality of parameters of the lens barrels and the spacing elements included in the optical imaging lens assemblies in this embodiment and Embodiment 3 are as shown in the following Table 9. The specific description of the plurality of parameters is the same as the related description in the above Embodiment 2, and thus will not be repeatedly described here.

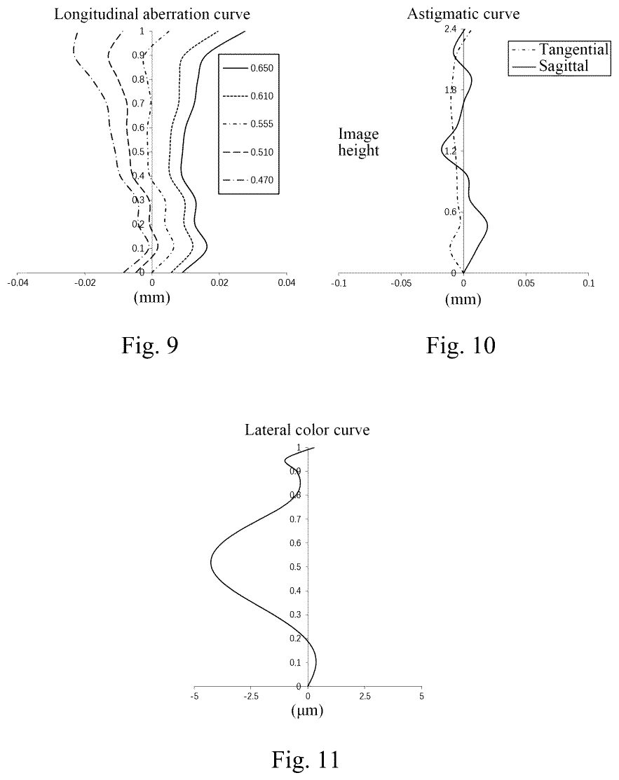

FIG. 9 illustrates a longitudinal aberration curve of the optical imaging lens assemblies of Embodiments 3 and 4, representing deviations of focal points of light of different wavelengths converged after passing through a lens assembly. FIG. 10 illustrates an astigmatic curve of the optical imaging lens assemblies of Embodiments 3 and 4, representing a curvature of a tangential image plane and a curvature of a sagittal image plane. FIG. 11 illustrates a lateral color curve of the optical imaging lens assemblies of Embodiments 3 and 4, representing deviations of different image heights on the image plane after light passes through a lens assembly. It can be seen from FIGS. 9-11 that the optical imaging lens assemblies given in Embodiments 3 and 4 can achieve a good imaging quality.

### Embodiment 5

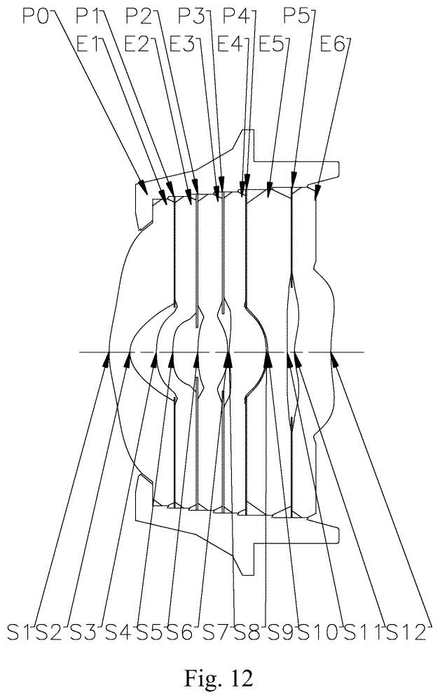

An optical imaging lens assembly according to Embodiment 5 of the present disclosure is described below with reference to FIG. 12.

As shown in FIG. 12, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side.

In this embodiment, the optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

In this embodiment, the first lens E1 has a negative refractive power, an object-side surface S1 of the first lens E1 is a convex surface, and the image-side surface S2 of the first lens E1 is a concave surface. The second lens E2 has a positive refractive power, an object-side surface S3 of the second lens E2 is a convex surface, and the image-side surface S4 of the second lens E2 is a concave surface. The third lens E3 has a positive refractive power, an object-side surface S5 of the third lens E3 is a convex surface, and the image-side surface S6 of the third lens E3 is a convex surface. The fourth lens E4 has a positive refractive power, an object-side surface S7 of the fourth lens E4 is a convex surface, and the image-side surface S8 of the fourth lens E4 is a convex surface. The fifth lens E5 has a negative refractive power, an object-side surface S9 of the fifth lens E5 is a concave surface, and the image-side surface S10 of the fifth lens E5 is a concave surface. The sixth lens E6 has a positive refractive power, an object-side surface S11 of the sixth lens E6 is a convex surface, and an image-side surface S12 of the sixth lens E6 is a concave surface.

In this embodiment, the optical imaging lens assembly may further include, for example, an optical filter (not shown) positioned on the image side of the sixth lens E6 and having an object-side surface S13 and an image-side surface S14, and an image plane S15 (not shown) positioned on the image side of optical filter. For example, light from an object may sequentially pass through the surfaces S1-S14, and finally form an image on the image plane S15.

Table 5 shows basic parameters of the optical imaging lens assembly of Embodiment 5. Here, the units of a radius of curvature and a thickness/distance are millimeters (mm).

TABLE 5

| | | | | material | | |
|---|---|---|---|---|---|---|
| surface | surface | radius of | thickness/ | refractive | abbe | conic |
| number | type | curvature | distance | index | number | coefficient |
| OBJ | spherical | infinite | 300.0000 | | | |
| S1 | aspheric | 2.1657 | 0.5008 | 1.53 | 55.7 | −1.0000 |
| S2 | aspheric | 0.5937 | 0.6400 | | | −1.1922 |
| S3 | aspheric | 1.9741 | 0.3977 | 1.64 | 23.5 | 0.0000 |
| S4 | aspheric | 3.0497 | 0.6022 | | | 0.0000 |
| STO | spherical | infinite | 0.0000 | | | |
| S5 | aspheric | 3.3925 | 0.7218 | 1.54 | 56.0 | 0.0000 |
| S6 | aspheric | −4.1046 | 0.0332 | | | 0.0000 |
| S7 | aspheric | 1.5466 | 0.8988 | 1.54 | 56.0 | 0.0000 |
| S8 | aspheric | −1.6457 | 0.0359 | | | 0.0000 |
| S9 | aspheric | −1.4811 | 0.4641 | 1.66 | 20.3 | 0.0000 |
| S10 | aspheric | 4.6974 | 0.1744 | | | 0.0000 |
| S11 | aspheric | 1.2059 | 0.8793 | 1.53 | 55.7 | −1.0000 |
| S12 | aspheric | 3.8879 | 0.4610 | | | 0.0000 |
| S13 | spherical | infinite | 0.2100 | 1.51 | 64.1 | |
| S14 | spherical | infinite | 0.2722 | | | |
| S15 | spherical | infinite | | | | |

In this embodiment, the object-side surface and the image-side surface of any lens in the first to sixth lenses E1-E6 are both aspheric surfaces, and the surface type of each aspheric surface may be defined using the formula (1) given in Embodiment 1. Table 6-1 and Table6-2 show the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in this embodiment.

TABLE 6-1

| surface | | | | | | | |
|---|---|---|---|---|---|---|---|
| number | A4 | A6 | A8 | A10 | A12 | A14 | A16 |
| S1 | −1.46E+00 | 4.21E−01 | −1.09E−01 | 3.51E−02 | −9.19E−03 | 3.21E−03 | −1.24E−03 |
| S2 | 6.23E−02 | 9.61E−03 | 5.79E−03 | −8.37E−04 | −5.15E−04 | 4.97E−04 | −3.50E−04 |
| S3 | 2.19E−01 | −8.17E−03 | −1.92E−02 | −8.24E−03 | −7.40E−04 | 1.23E−03 | 5.66E−04 |
| S4 | 1.94E−01 | 2.91E−02 | 4.70E−03 | −7.72E−06 | −3.30E−04 | −1.47E−04 | −1.10E−04 |
| S5 | 2.66E−02 | 2.79E−03 | 5.13E−04 | 1.01E−04 | 2.81E−05 | −6.68E−06 | −3.57E−05 |
| S6 | −2.03E−01 | 5.56E−02 | −9.27E−03 | 5.45E−03 | −2.05E−03 | 7.18E−04 | −1.97E−04 |
| S7 | −3.65E−01 | 5.52E−02 | −1.55E−02 | 8.77E−03 | −3.65E−03 | 7.25E−04 | −8.14E−04 |
| S8 | −1.58E−01 | 2.60E−02 | 1.83E−02 | 4.06E−03 | 4.04E−03 | −2.21E−03 | 1.02E−03 |
| S9 | −7.18E−02 | 1.46E−02 | 1.00E−02 | 2.05E−03 | 1.13E−03 | −2.11E−03 | 1.43E−03 |
| S10 | −2.53E−01 | 8.65E−02 | −3.89E−02 | 1.67E−02 | −7.47E−03 | 2.60E−03 | −5.57E−04 |
| S11 | −1.27E+00 | 2.38E−01 | −5.29E−02 | 1.82E−02 | −7.19E−03 | 2.69E−03 | −1.33E−03 |
| S12 | −8.42E−01 | −3.09E−02 | 1.25E−02 | 4.06E−03 | 1.59E−04 | 1.85E−03 | −8.39E−04 |

TABLE 6-2

| surface | | | | | | | |
|---|---|---|---|---|---|---|---|
| number | A18 | A20 | A22 | A24 | A26 | A28 | A30 |
| S1 | 9.53E−04 | −7.49E−04 | 5.20E−04 | −3.32E−04 | 1.61E−04 | −3.29E−05 | 2.00E−06 |
| S2 | −4.54E−04 | 0.00E+00 | 0.00E+00 | 0.00E+00 | 0.00E+00 | 0.00E+00 | 0.00E+00 |
| S3 | 1.03E−04 | −4.01E−05 | −3.02E−06 | −3.75E−07 | −4.61E−08 | 0.00E+00 | 0.00E+00 |
| S4 | −5.24E−05 | 1.03E−06 | −6.46E−07 | −1.99E−05 | −8.67E−06 | 6.31E−06 | 6.26E−06 |
| S5 | −1.83E−05 | −2.14E−07 | 0.00E+00 | 0.00E+00 | 0.00E+00 | 0.00E+00 | 0.00E+00 |
| S6 | 1.94E−04 | 7.49E−06 | 4.20E−07 | 0.00E+00 | 0.00E+00 | 0.00E+00 | 0.00E+00 |
| S7 | 2.82E−04 | −8.58E−05 | 2.56E−05 | −6.13E−05 | −7.58E−06 | −7.05E−06 | 4.38E−06 |
| S8 | −1.55E−03 | −3.87E−05 | −5.63E−05 | −8.09E−06 | −3.16E−07 | −1.42E−06 | 0.00E+00 |
| S9 | −1.10E−03 | 1.45E−04 | 1.25E−05 | −4.74E−05 | −3.39E−05 | −2.20E−05 | 1.10E−05 |
| S10 | 2.48E−05 | 2.09E−05 | 4.29E−05 | −3.36E−05 | 0.00E+00 | 0.00E+00 | 0.00E+00 |
| S11 | 7.34E−04 | −3.28E−04 | 1.31E−04 | −2.74E−05 | 0.00E+00 | 0.00E+00 | 0.00E+00 |
| S12 | 5.85E−04 | −2.89E−04 | −7.99E−06 | −6.51E−06 | 9.94E−08 | 0.00E+00 | 0.00E+00 |

### Embodiment 6

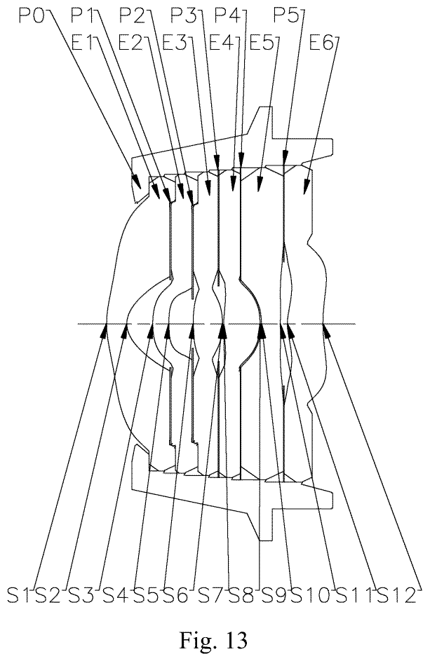

An optical imaging lens assembly according to Embodiment 6 of the present disclosure is described below with reference to FIG. 13.

As shown in FIG. 13, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side. The optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

The structure of the optical imaging lens assembly in this embodiment is the same as that of the optical imaging lens assembly in Embodiment 5, that is, the table of the basic parameters of the optical imaging lens assembly in this embodiment is the same as Table 5, and the tables of the high-order coefficients of the aspheric surfaces are the same as Table 6-1 and Table 6-2.

This embodiment differs from Embodiment 5 in that the structure sizes of the lens barrels and some spacing elements and the spacing distances between some of the spacing elements along the direction of the optical axis are different. The numerical values of a plurality of parameters of the lens barrels and the spacing elements included in the optical imaging lens assemblies in this embodiment and Embodiment 5 are as shown in the following Table 9. The specific description of the plurality of parameters is the same as the related description in the above Embodiment 2, and thus will not be repeatedly described here.

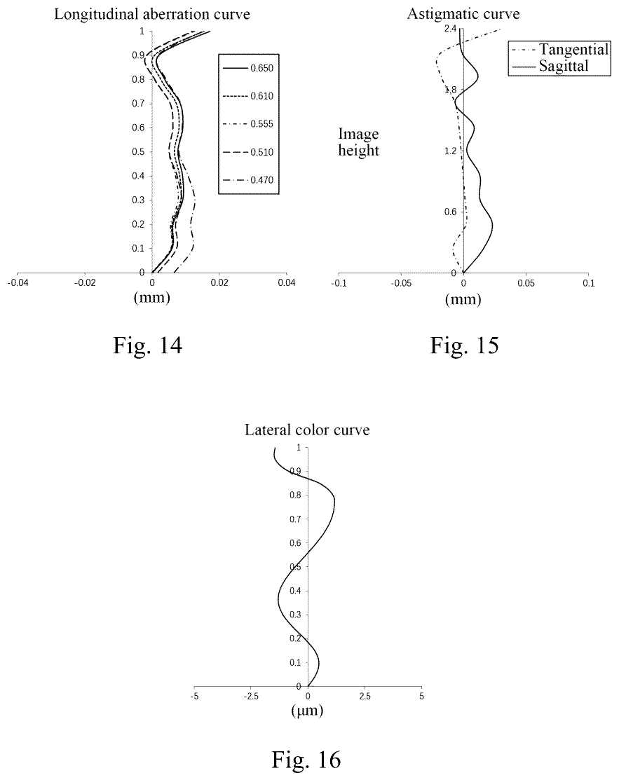

FIG. 14 illustrates a longitudinal aberration curve of the optical imaging lens assemblies of Embodiments 5 and 6, representing deviations of focal points of light of different wavelengths converged after passing through a lens assembly. FIG. 15 illustrates an astigmatic curve of the optical imaging lens assemblies of Embodiments 5 and 6, representing a curvature of a tangential image plane and a curvature of a sagittal image plane. FIG. 16 illustrates a lateral color curve of the optical imaging lens assemblies of Embodiments 5 and 6, representing deviations of different image heights on the image plane after light passes through a lens assembly. It can be seen from FIGS. 14-16 that the optical imaging lens assemblies given in Embodiments 5 and 6 can achieve a good imaging quality.

### Embodiment 7

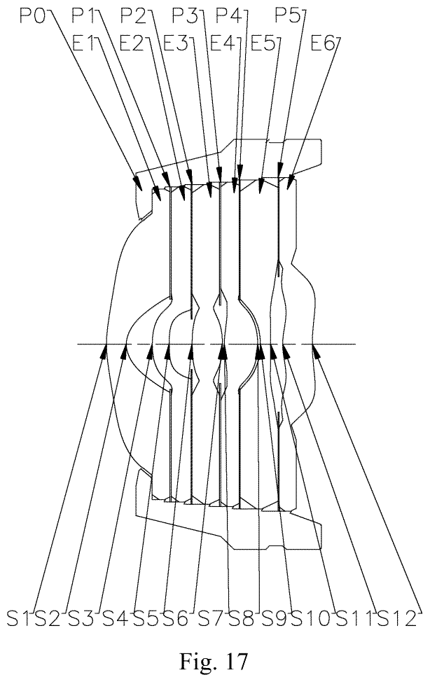

An optical imaging lens assembly according to Embodiment 7 of the present disclosure is described below with reference to FIG. 17.

As shown in FIG. 17, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side.

In this embodiment, the optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

In this embodiment, the first lens E1 has a negative refractive power, an object-side surface S1 of the first lens E1 is a convex surface, and the image-side surface S2 of the first lens E1 is a concave surface. The second lens E2 has a positive refractive power, an object-side surface S3 of the second lens E2 is a convex surface, and the image-side surface S4 of the second lens E2 is a concave surface. The third lens E3 has a positive refractive power, an object-side surface S5 of the third lens E3 is a convex surface, and the image-side surface S6 of the third lens E3 is a convex surface. The fourth lens E4 has a positive refractive power, an object-side surface S7 of the fourth lens E4 is a convex surface, and the image-side surface S8 of the fourth lens E4 is a convex surface. The fifth lens E5 has a negative refractive power, an object-side surface S9 of the fifth lens E5 is a concave surface, and the image-side surface S10 of the fifth lens E5 is a concave surface. The sixth lens E6 has a positive refractive power, an object-side surface S11 of the sixth lens E6 is a convex surface, and an image-side surface S12 of the sixth lens E6 is a concave surface.

In this embodiment, the optical imaging lens assembly may further include, for example, an optical filter (not shown) positioned on the image side of the sixth lens E6 and having an object-side surface S13 and an image-side surface S14, and an image plane S15 (not shown) positioned on the image side of optical filter. For example, light from an object may sequentially pass through the surfaces S1-S14, and finally form an image on the image plane S15.

Table 7 shows basic parameters of the optical imaging lens assembly of Embodiment 7. Here, the units of a radius of curvature and a thickness/distance are millimeters (mm).

TABLE 7

| | | | | material | | |
|---|---|---|---|---|---|---|
| surface | surface | radius of | thickness/ | refractive | abbe | conic |
| number | type | curvature | distance | index | number | coefficient |
| OBJ | spherical | infinite | 300.0000 | | | |
| S1 | aspheric | 2.6293 | 0.4904 | 1.53 | 55.7 | −1.0000 |
| S2 | aspheric | 0.6263 | 0.6399 | | | −1.1403 |
| S3 | aspheric | 1.8847 | 0.4154 | 1.64 | 23.5 | 0.0000 |
| S4 | aspheric | 3.1272 | 0.5674 | | | −0.5102 |
| STO | spherical | infinite | 0.0000 | | | |
| S5 | aspheric | 3.2401 | 0.7472 | 1.54 | 56.0 | 0.0000 |
| S6 | aspheric | −4.8290 | 0.0480 | | | 0.0000 |
| S7 | aspheric | 1.5063 | 0.8256 | 1.54 | 56.0 | 0.0000 |
| S8 | aspheric | −1.6082 | 0.0657 | | | 0.0000 |
| S9 | aspheric | −1.6263 | 0.2500 | 1.66 | 20.3 | 0.0000 |
| S10 | aspheric | 7.4909 | 0.2983 | | | 0.0000 |
| S11 | aspheric | 1.4807 | 0.7310 | 1.53 | 55.7 | −1.0000 |
| S12 | aspheric | 4.0015 | 0.4381 | | | 0.0000 |
| S13 | spherical | infinite | 0.2100 | 1.51 | 64.1 | |
| S14 | spherical | infinite | 0.2722 | | | |
| S15 | spherical | infinite | | | | |

In this embodiment, the object-side surface and the image-side surface of any lens in the first to sixth lenses E1-E6 are both aspheric surfaces, and the surface type of each aspheric surface may be defined using the formula (1) given in Embodiment 1. Table 8-1 and Table 8-2 show the high-order coefficients A₄, A₆, A₈, A₁₀, A₁₂, A₁₄, A₁₆, A₁₈, A₂₀, A₂₂, A₂₄, A₂₆, A₂₈ and A₃₀ applicable to the aspheric surfaces S1-S12 in this embodiment.

TABLE 8-1

| surface | | | | | | | |
|---|---|---|---|---|---|---|---|
| number | A4 | A6 | A8 | A10 | A12 | A14 | A16 |
| S1 | −1.18E+00 | 4.02E−01 | −9.87E−02 | 3.81E−02 | −1.28E−02 | 7.91E−03 | −4.28E−03 |
| S2 | 8.99E−02 | 7.23E−04 | 5.65E−05 | 6.06E−03 | −2.66E−03 | −3.33E−03 | −1.53E−03 |
| S3 | 2.20E−01 | −2.41E−02 | −2.34E−02 | −5.28E−03 | 1.05E−03 | 1.25E−03 | 3.79E−04 |
| S4 | 2.17E−01 | 2.88E−02 | 3.60E−03 | 0.00E+00 | 0.00E+00 | 0.00E+00 | 0.00E+00 |
| S5 | 2.62E−02 | 2.31E−03 | 2.35E−04 | 3.44E−06 | 4.95E−05 | 2.67E−05 | −7.84E−06 |
| S6 | −1.80E−01 | 4.66E−02 | −6.34E−03 | 3.75E−03 | −1.26E−03 | 3.63E−04 | −1.14E−04 |
| S7 | −3.51E−01 | 4.55E−02 | −1.15E−02 | 6.93E−03 | −2.46E−03 | 3.12E−04 | −5.38E−04 |
| S8 | −8.04E−02 | 9.29E−03 | 2.21E−02 | 3.87E−03 | 3.27E−03 | −1.55E−03 | 2.42E−04 |
| S9 | −8.03E−02 | 8.10E−03 | 6.46E−03 | 3.51E−03 | 4.25E−04 | −1.51E−03 | 9.79E−04 |
| S10 | −8.61E−02 | 6.28E−02 | −3.49E−02 | 1.38E−02 | −5.31E−03 | 1.85E−03 | −2.22E−04 |
| S11 | −1.26E+00 | 3.05E−01 | −5.33E−02 | 3.63E−04 | −1.71E−03 | 3.13E−03 | −8.03E−04 |
| S12 | −9.90E−01 | −2.04E−02 | 3.61E−02 | 1.05E−02 | −1.02E−03 | −3.85E−03 | −1.63E−03 |

TABLE 8-2

| surface | | | | | | | |
|---|---|---|---|---|---|---|---|
| number | A18 | A20 | A22 | A24 | A26 | A28 | A30 |
| S1 | 2.76E−03 | −1.38E−03 | 6.61E−04 | −2.85E−04 | 1.35E−04 | −1.15E−05 | 6.16E−05 |
| S2 | −4.21E−04 | 0.00E+00 | 0.00E+00 | 0.00E+00 | 0.00E+00 | 0.00E+00 | 0.00E+00 |
| S3 | −2.61E−06 | −5.23E−05 | −5.25E−06 | −7.32E−07 | 0.00E+00 | 0.00E+00 | 0.00E+00 |
| S4 | 0.00E+00 | 0.00E+00 | 0.00E+00 | 0.00E+00 | 0.00E+00 | 0.00E+00 | 0.00E+00 |
| S5 | −5.42E−06 | 0.00E+00 | 0.00E+00 | 0.00E+00 | 0.00E+00 | 0.00E+00 | 0.00E+00 |
| S6 | 1.11E−04 | 3.14E−06 | 1.40E−07 | 0.00E+00 | 0.00E+00 | 0.00E+00 | 0.00E+00 |
| S7 | 1.87E−04 | −4.14E−07 | 4.31E−05 | −2.82E−05 | −2.00E−05 | −1.37E−05 | −8.32E−06 |
| S8 | −1.24E−03 | −2.87E−04 | −1.53E−04 | −1.74E−05 | −2.76E−06 | −4.82E−07 | −7.41E−08 |
| S9 | −1.02E−03 | −1.09E−04 | −1.18E−04 | −6.01E−05 | −5.34E−05 | −4.18E−05 | −1.22E−05 |
| S10 | −4.23E−04 | 3.15E−04 | −9.39E−05 | 1.14E−05 | 0.00E+00 | 0.00E+00 | 0.00E+00 |
| S11 | −2.38E−04 | −4.97E−05 | 1.97E−04 | −6.10E−05 | 1.09E−08 | 0.00E+00 | 0.00E+00 |
| S12 | −3.74E−05 | 4.76E−04 | 4.22E−04 | 1.91E−04 | 6.59E−06 | 0.00E+00 | 0.00E+00 |

### Embodiment 8

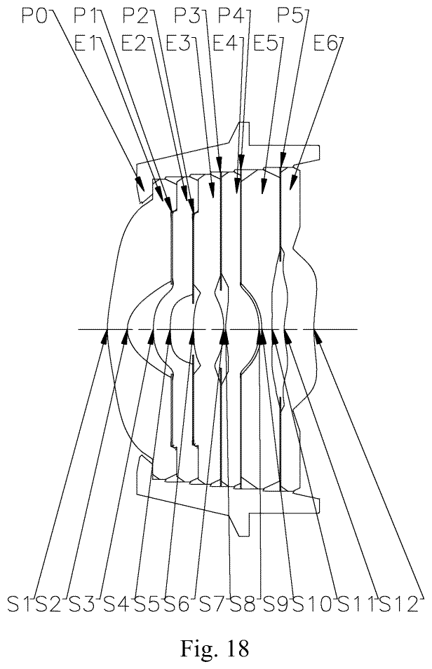

An optical imaging lens assembly according to Embodiment 8 of the present disclosure is described below with reference to FIG. 18.

As shown in FIG. 18, in this embodiment, the optical imaging lens assembly includes a lens barrel P0, and a first lens E1, a second lens E2, a third lens E3, a fourth lens E4, a fifth lens E5 and a sixth lens E6 that are accommodated in the lens barrel P0 and arranged sequentially along an optical axis from an object side to an image side. The optical imaging lens assembly further includes a plurality of spacing elements: a first spacing element P1, positioned between the first lens E1 and the second lens E2 and in direct contact with an image-side surface of the first lens E1; a second spacing element P2, positioned between the second lens E2 and the third lens E3 and in direct contact with an image-side surface of the second lens E2; a third spacing element P3, positioned between the third lens E3 and the fourth lens E4 and in direct contact with an image-side surface of the third lens E3; a fourth spacing element P4, positioned between the fourth lens E4 and the fifth lens E5 and in direct contact with an image-side surface of the fourth lens E4; and a fifth spacing element P5, positioned between the fifth lens E5 and the sixth lens E6 and in direct contact with an image-side surface of the fifth lens E5.

The structure of the optical imaging lens assembly in this embodiment is the same as that of the optical imaging lens assembly in Embodiment 7, that is, the table of the basic parameters of the optical imaging lens assembly in this embodiment is the same as Table 7, and the tables of the high-order coefficients of the aspheric surfaces are the same as Table 8-1 and Table8-2.

This embodiment differs from Embodiment 7 in that the structure sizes of the lens barrels and some spacing elements and the spacing distances between some of the spacing elements along the direction of the optical axis are different. The numerical values of a plurality of parameters of the lens barrels and the spacing elements included in the optical imaging lens assemblies in this embodiment and Embodiment 7 are as shown in the following Table 9. The specific description of the plurality of parameters is the same as the related description in the above Embodiment 2, and thus will not be repeatedly described here.

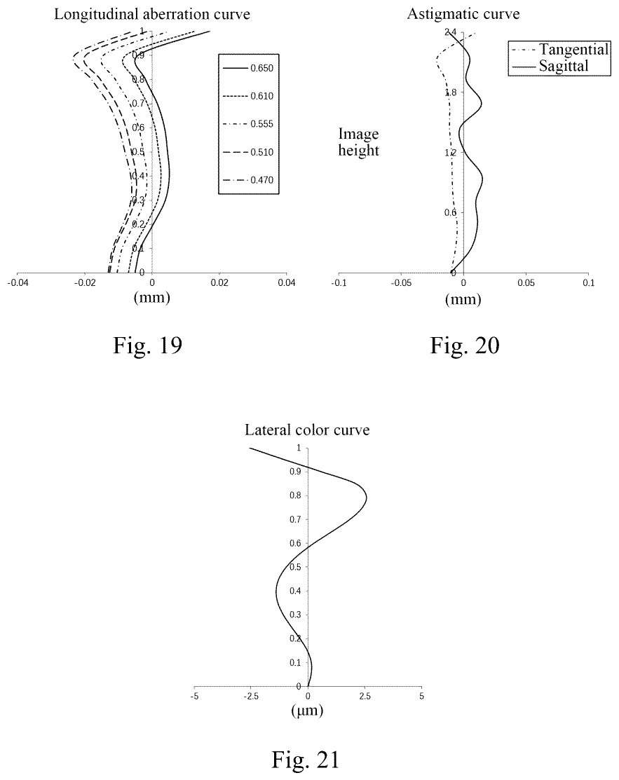

FIG. 19 illustrates a longitudinal aberration curve of the optical imaging lens assemblies of Embodiments 7 and 8, representing deviations of focal points of light of different wavelengths converged after passing through a lens assembly. FIG. 20 illustrates an astigmatic curve of the optical imaging lens assemblies of Embodiments 7 and 8, representing a curvature of a tangential image plane and a curvature of a sagittal image plane. FIG. 21 illustrates a lateral color curve of the optical imaging lens assemblies of Embodiments 7 and 8, representing deviations of different image heights on the image plane after light passes through a lens assembly. It can be seen from FIGS. 19-21 that the optical imaging lens assemblies given in Embodiments 7 and 8 can achieve a good imaging quality.

TABLE 9

| | Embodiment | | | | | | | |
|---|---|---|---|---|---|---|---|---|
| Parameter | 1 | 2 | 3 | 4 | 5 | 6 | 7 | 8 |
| d1s(mm) | 2.663 | 2.620 | 2.058 | 2.068 | 2.161 | 2.170 | 2.201 | 2.193 |
| d1m(mm) | 2.663 | 2.620 | 2.058 | 2.068 | 2.161 | 2.170 | 2.201 | 2.193 |
| D1s(mm) | 8.195 | 6.661 | 6.742 | 5.699 | 7.452 | 5.963 | 7.697 | 5.711 |
| D2s(mm) | 8.309 | 6.436 | 6.856 | 7.191 | 7.565 | 5.837 | 7.811 | 5.628 |
| D3s(mm) | 8.422 | 6.220 | 6.969 | 7.304 | 7.679 | 7.590 | 7.925 | 7.661 |
| D3m(mm) | 8.422 | 6.220 | 6.969 | 7.304 | 7.679 | 7.590 | 7.925 | 7.661 |
| d4m(mm) | 2.158 | 2.160 | 2.133 | 2.131 | 2.125 | 2.126 | 2.168 | 2.167 |
| d5s(mm) | 3.801 | 3.711 | 3.183 | 3.336 | 3.104 | 3.054 | 3.301 | 3.313 |
| D5m(mm) | 8.652 | 8.404 | 7.196 | 7.531 | 7.906 | 7.817 | 8.152 | 7.888 |
| D0s(mm) | 8.918 | 8.601 | 7.386 | 8.041 | 8.042 | 8.177 | 8.365 | 8.040 |
| d0s(mm) | 7.436 | 7.480 | 6.204 | 6.332 | 6.688 | 6.795 | 6.939 | 6.988 |
| EP01(mm) | 0.954 | 0.963 | 0.934 | 0.939 | 0.929 | 0.938 | 0.839 | 0.847 |
| EP12(mm) | 0.552 | 0.546 | 0.604 | 0.613 | 0.510 | 0.517 | 0.494 | 0.492 |
| EP34(mm) | 0.395 | 0.378 | 0.647 | 0.631 | 0.525 | 0.524 | 0.464 | 0.472 |
| EP45(mm) | 1.219 | 1.170 | 1.110 | 1.139 | 1.077 | 1.056 | 0.935 | 0.946 |
| CP1(mm) | 0.016 | 0.020 | 0.022 | 0.018 | 0.024 | 0.033 | 0.030 | 0.035 |
| CP3(mm) | 0.045 | 0.022 | 0.022 | 0.030 | 0.040 | 0.022 | 0.028 | 0.030 |
| CP4(mm) | 0.016 | 0.018 | 0.040 | 0.018 | 0.016 | 0.018 | 0.020 | 0.016 |
| CP5(mm) | 0.040 | 0.038 | 0.020 | 0.040 | 0.026 | 0.016 | 0.025 | 0.022 |

In addition, in Embodiments 1-8, the effective focal length f of the optical imaging lens assembly, the effective focal length values f1-f6 of the lenses, the entrance pupil diameter EPD of the optical imaging lens assembly, the maximal effective radius DT11 of the object-side surface of the first lens, the maximal effective radius DT12 of the image-side surface of the first lens, the maximal effective radius DT22 of the image-side surface of the second lens, the maximal effective radius DT61 of the object-side surface of the sixth lens and the half of the maximal field-of-view Semi-FOV of the optical imaging lens assembly are respectively as shown in Table 10 below.

TABLE 10

| | Embodiment | | | | | | | |
|---|---|---|---|---|---|---|---|---|
| Parameter | 1 | 2 | 3 | 4 | 5 | 6 | 7 | 8 |
| f (mm) | 1.32 | 1.32 | 1.36 | 1.36 | 1.37 | 1.37 | 1.32 | 1.32 |
| f1 (mm) | −1.99 | −1.99 | −1.73 | −1.73 | −1.71 | −1.71 | −1.67 | −1.67 |
| f2 (mm) | 7.58 | 7.58 | 11.06 | 11.06 | 7.58 | 7.58 | 6.51 | 6.51 |
| f3 (mm) | 3.40 | 3.40 | 4.37 | 4.37 | 3.52 | 3.52 | 3.67 | 3.67 |
| f4 (mm) | 1.80 | 1.80 | 1.78 | 1.78 | 1.62 | 1.62 | 1.57 | 1.57 |
| f5 (mm) | −2.03 | −2.03 | −1.74 | −1.74 | −1.64 | −1.64 | −1.98 | −1.98 |
| f6 (mm) | 4.11 | 4.11 | 2.18 | 2.18 | 2.92 | 2.92 | 3.98 | 3.98 |
| EPD (mm) | 0.69 | 0.69 | 0.67 | 0.67 | 0.69 | 0.69 | 0.71 | 0.71 |
| DT11 (mm) | 8.22 | 8.22 | 2.60 | 2.60 | 2.83 | 2.83 | 2.96 | 2.96 |
| DT12 (mm) | 3.21 | 3.21 | 1.09 | 1.09 | 1.14 | 1.14 | 1.16 | 1.16 |
| DT22 (mm) | 1.01 | 1.01 | 0.71 | 0.71 | 0.75 | 0.75 | 0.76 | 0.76 |
| DT61 (mm) | 2.13 | 2.13 | 1.80 | 1.80 | 1.60 | 1.60 | 1.80 | 1.80 |
| Semi-FOV (°) | 79.2 | 79.2 | 78.9 | 78.9 | 78.8 | 78.8 | 79.2 | 79.2 |

Embodiments 1-8 respectively satisfy the conditions shown in Table 11 below.

TABLE 11

| | Embodiment | | | | | | | |
|---|---|---|---|---|---|---|---|---|
| Conditional expression | 1 | 2 | 3 | 4 | 5 | 6 | 7 | 8 |
| (D0s − d0s)/(EPD × tan(Semi-FOV)) | 0.41 | 0.31 | 0.35 | 0.50 | 0.39 | 0.40 | 0.38 | 0.28 |
| d1m/(R2 × N1) | 2.77 | 2.72 | 2.24 | 2.25 | 2.38 | 2.39 | 2.30 | 2.29 |
| V1 × (EP01 + CP1)/(f1 × R1) | −14.68 | −14.87 | −14.26 | −14.27 | −14.30 | −14.57 | −10.99 | −11.16 |
| (DT11 − DT12)/(D1s − d1s) | 0.90 | 1.24 | 0.32 | 0.41 | 0.32 | 0.44 | 0.33 | 0.51 |
| D2s/DT22 | 8.22 | 6.37 | 9.64 | 10.11 | 10.04 | 7.75 | 10.24 | 7.38 |
| \|R3 × f2\|/(N2 + CT2 + EP12) (mm) | 5.15 | 5.17 | 8.38 | 8.36 | 5.88 | 5.86 | 4.81 | 4.81 |
| (T34 − CP3) × V3/f3 | 0.41 | 0.79 | 0.10 | 0.00 | −0.11 | 0.18 | 0.31 | 0.27 |
| D3s/R6 + D3m/R7 | 1.65 | 1.22 | 2.54 | 2.66 | 3.09 | 3.06 | 3.62 | 3.50 |
| (EP34 + CP4)/(f4 × N4) | 0.15 | 0.14 | 0.25 | 0.24 | 0.22 | 0.22 | 0.20 | 0.20 |
| (d5s − d4m)/R10 | −0.54 | −0.51 | 0.30 | 0.34 | 0.21 | 0.20 | 0.15 | 0.15 |
| D5m/DT61 | 4.07 | 3.95 | 4.00 | 4.19 | 4.94 | 4.89 | 4.54 | 4.39 |
| (EP45 + CP5 + CT5)/R12 | 0.66 | 0.64 | −0.09 | −0.10 | 0.40 | 0.40 | 0.30 | 0.30 |

The present disclosure further provides an imaging apparatus having an electronic photosensitive element for imaging, where the electronic photosensitive element may be a charge coupled device (CCD) or complementary metal-oxide semiconductor element (CMOS). The imaging apparatus may be an independent imaging device such as a digital camera, or may be an imaging module integrated in a mobile electronic device such as a mobile phone. The imaging apparatus is equipped with the optical imaging lens assembly described above.

The foregoing is only a description for the preferred embodiments of the present disclosure and the applied technical principles. It should be appreciated by those skilled in the art that the scope of protection involved in the present disclosure is not limited to the technical solution formed by the particular combination of the above technical features. The scope of protection should also cover other technical solutions formed by any combination of the above technical features or equivalent features thereof without departing from the concept of the present disclosure, for example, technical solutions formed by replacing the features disclosed in the present disclosure with (but not limited to) technical features with similar functions.

What is claimed is:

1. An optical imaging lens assembly, comprising a lens barrel, and a lens group and at least one spacing element that are accommodated in the lens barrel,
wherein the lens group comprises a first lens, a second lens, a third lens, a fourth lens, a fifth lens and a sixth lens that are sequentially arranged along an optical axis from an object side to an image side; the first lens has a negative refractive power, an object-side surface of the first lens is a convex surface, and an image-side surface of the first lens is a concave surface; the second lens has a positive refractive power, an object-side surface of the second lens is a convex surface, and an image-side surface of the second lens is a concave surface; the third lens has a positive refractive power, an object-side surface of the third lens is a convex surface, and an image-side surface of the third lens is a convex surface; the fourth lens has a positive refractive power, an object-side surface of the fourth lens is a convex surface, and an image-side surface of the fourth lens is a convex surface; the fifth lens has a negative refractive power, and an object-side surface of the fifth lens is a concave surface; and the sixth lens has a positive refractive power, and an object-side surface of the sixth lens is a convex surface,
the at least one spacing element comprises: a first spacing element, positioned between the first lens and the second lens and in direct contact with the image-side surface of the first lens, and
the optical imaging lens assembly satisfies:
$$0.28 \leq ( D 0 s - d 0 s ) / ( EPD \times tan ( Semi - F O V ) ) \leq 0.5 , and$$
$$2.24 \leq d 1 m / ( R 2 \times N 1 ) \leq 2.77 ,$$
wherein D0s is an outer diameter of an object-side end surface of the lens barrel, dos is an inner diameter of the object-side end surface of the lens barrel, EPD is an entrance pupil diameter of the optical imaging lens assembly, Semi-FOV is half of a maximal field-of-view of the optical imaging lens assembly, d1m is an inner diameter of an image-side surface of the first spacing element, R2 is a radius of curvature of the image-side surface of the first lens, and N1 is a refractive index of the first lens.

2. The optical imaging lens assembly according to claim 1, wherein an abbe number V1 of the first lens, a distance EP01 from the object-side end surface of the lens barrel to an object-side surface of the first spacing element on the optical axis, a maximal thickness CP1 of the first spacing element, an effective focal length f1 of the first lens and a radius of curvature R1 of the object-side surface of the first lens satisfy:
$$- 14.87 \leq V 1 \times ( EP 01 + CP 1 ) / ( f 1 \times R 1 ) \leq - 10.99 .$$

3. The optical imaging lens assembly according to claim 1, wherein a maximal effective radius DT11 of the object-side surface of the first lens, a maximal effective radius DT12 of the image-side surface of the first lens, an outer diameter D1s of the object-side surface of the first spacing element and an inner diameter d1s of the object-side surface of the first spacing element satisfy:
$$0.3 < ( DT 11 - DT 12 ) / ( D 1 s - d 1 s ) \leq 1.24 .$$

4. The optical imaging lens assembly according to claim 1, wherein the at least one spacing element further comprises: a second spacing element, positioned between the second lens and the third lens and in direct contact with the image-side surface of the second lens, and
an outer diameter D2s of an object-side surface of the second spacing element and a maximal effective radius DT22 of the image-side surface of the second lens satisfy:
$$6.37 \leq D 2 s / DT 22 \leq 10.24 .$$

5. The optical imaging lens assembly according to claim 1, wherein the at least one spacing element further comprises: a second spacing element, positioned between the second lens and the third lens and in direct contact with the image-side surface of the second lens, and
a radius of curvature R3 of the object-side surface of the second lens, an effective focal length f2 of the second lens, a refractive index N2 of the second lens, a center thickness CT2 of the second lens on the optical axis and a distance EP12 from the image-side surface of the first spacing element to an object-side surface of the second spacing element on the optical axis satisfy:
$$4.81 mm \leq \vert R 3 \times f 2 \vert / ( N 2 + CT 2 + EP 12 ) \leq 8.38 mm .$$

6. The optical imaging lens assembly according to claim 1, wherein the at least one spacing element further comprises: a third spacing element, positioned between the third lens and the fourth lens and in direct contact with the image-side surface of the third lens, and
an air spacing T34 between the third lens and the fourth lens on the optical axis, a maximal thickness CP3 of the third spacing element, an abbe number V3 of the third lens and an effective focal length f3 of the third lens satisfy:
$$- 0.11 \leq ( T 34 - CP 3 ) \times V 3 / f 3 \leq 0.79 .$$

7. The optical imaging lens assembly according to claim 1, wherein the at least one spacing element further comprises: a third spacing element, positioned between the third lens and the fourth lens and in direct contact with the image-side surface of the third lens, and
an outer diameter D3s of an object-side surface of the third spacing element, a radius of curvature R6 of the image-side surface of the third lens, an outer diameter D3m of an image-side surface of the third spacing element and a radius of curvature R7 of the object-side surface of the fourth lens satisfy:
$$1.22 \leq D 3 s / R 6 + D 3 m / R 7 \leq 3.62 .$$

8. The optical imaging lens assembly according to claim 1, wherein the at least one spacing element further comprises: a third spacing element, positioned between the third lens and the fourth lens and in direct contact with the image-side surface of the third lens; and a fourth spacing element, positioned between the fourth lens and the fifth lens and in direct contact with the image-side surface of the fourth lens, and a distance EP34 from an image-side surface of the third spacing element to an object-side surface of the fourth spacing element on the optical axis, a maximal thickness CP4 of the fourth spacing element, an effective focal length f4 of the fourth lens and a refractive index N4 of the fourth lens satisfy:
$$0.14 \leq ( EP 34 + CP 4 ) / ( f 4 \times N 4 ) \leq 0.25 .$$

9. The optical imaging lens assembly according to claim 1, wherein the at least one spacing element further comprises: a fourth spacing element, positioned between the fourth lens and the fifth lens and in direct contact with the image-side surface of the fourth lens; and a fifth spacing element, positioned between the fifth lens and the sixth lens and in direct contact with an image-side surface of the fifth lens, and
an inner diameter d5s of an object-side surface of the fifth spacing element, an inner diameter d4m of an image-side surface of the fourth spacing element and a radius of curvature R10 of the image-side surface of the fifth lens satisfy:
$$- 0.54 \leq ( d 5 s - d 4 m ) / R 10 \leq 0.34 .$$

10. The optical imaging lens assembly according to claim 1, wherein the at least one spacing element further comprises: a fifth spacing element, positioned between the fifth lens and the sixth lens and in direct contact with an image-side surface of the fifth lens, and
an outer diameter D5m of an image-side surface of the fifth spacing element and a maximal effective radius DT61 of the object-side surface of the sixth lens satisfy:
$$3.95 \leq D 5 m / DT 61 < 4.94 .$$

11. The optical imaging lens assembly according to claim 1, wherein the at least one spacing element further comprises: a fourth spacing element, positioned between the fourth lens and the fifth lens and in direct contact with the image-side surface of the fourth lens; and a fifth spacing element, positioned between the fifth lens and the sixth lens and in direct contact with an image-side surface of the fifth lens, and
a distance EP45 from an image-side surface of the fourth spacing element to an object-side surface of the fifth spacing element on the optical axis, a maximal thickness CP5 of the fifth spacing element, a center thickness CT5 of the fifth lens on the optical axis and a radius of curvature R12 of an image-side surface of the sixth lens satisfy:
$$- 0.10 \leq ( EP 45 + CP 5 + CT 5 ) / R 12 \leq 0.66 .$$
